(19) United States
(12) Patent Application Publication
(10) Pub. No.: US 2026/0252198 A1
(43) Pub. Date: Aug. 27, 2026

(54) ELECTRONIC DEVICE

(71) Applicant: Samsung Display Co., Ltd., Yongin-si (KR)

(72) Inventors: Miyoung KIM, Yongin-si (KR); Sanghyun LIM, Yongin-si (KR)

(73) Assignee: Samsung Display Co., Ltd., Yongin-si (KR)

(21) Appl. No.: 19/333,967

(22) Filed: Sep. 19, 2025

(30) Foreign Application Priority Data
Feb. 27, 2025 (KR) 10-2025-0025758
Mar. 31, 2025 (KR) 10-2025-0041187

(51) Int. Cl. G06F 3/044

(52) U.S. Cl. CPC G06F 3/0446; G06F 2203/04106

(57) ABSTRACT

An electronic device comprises a display layer configured to display an image, a sensor layer on the display layer, and a cover substrate on the sensor layer. The cover substrate includes a first layer on the sensor layer, a second layer on the first layer, a third layer on the second layer, and a fourth layer on the third layer. At least one layer of the first layer, the second layer, the third layer, or the fourth layer includes a material configured to form an electric field based on a first input received at the at least one layer from an input device such that a magnitude of the electric field in a first direction is greater than a magnitude of the electric field in a second direction that intersects the first direction.

### CROSS-REFERENCE TO RELATED APPLICATIONS

This U.S. non-provisional patent application claims priority under 35 U.S.C. § 119 of Korean Patent Application No. 10-2025-0025758, filed on Feb. 27, 2025 in the Korean Intellectual Property Office, and Korean Patent Application No. 10-2025-0041187, filed on Mar. 31, 2025 in the Korean Intellectual Property Office, the entire contents of each of which are hereby incorporated by reference.

### BACKGROUND

The present inventive concepts relate to electronic devices for displaying an image.

An electronic device such as a television, a mobile phone, a tablet computer, a navigation system, a game machine, or the like generates an image and provides the generated image to a user through a display screen.

An electronic device may sense an external input as well as display an image. The external input may be an input of a user. The user's input may include various forms of external inputs, such as part of the user's body, light, heat, pen, or pressure. The electronic device may recognize the coordinates of a pen by using an electromagnetic resonance (EMR) method or recognize the coordinates of the pen by using an active electrostatic (AES) method.

### SUMMARY

The present inventive concepts provide electronic devices configured to exhibit improved sensing reliability in sensing a pen input.

Some example embodiments of the inventive concepts provide an electronic device that may include a display layer configured to display an image, a sensor layer on the display layer, and a cover substrate on the sensor layer. The cover substrate may include a first layer on the sensor layer, a second layer on the first layer, a third layer on the second layer, and a fourth layer on the third layer. At least one layer of the first layer, the second layer, the third layer, or the fourth layer may include a material configured to form an electric field based on a first input received at the at least one layer from an input device such that a magnitude of the electric field in a first direction is greater than a magnitude of the electric field in a second direction that intersects the first direction.

In some example embodiments, the at least one layer may have a dielectric anisotropic structure configured to exhibit a first dielectric constant in the first direction and a second dielectric constant in the second direction, the first dielectric constant greater than the second dielectric constant.

In some example embodiments, each layer of the second layer and the fourth layer has a dielectric anisotropic structure configured to exhibit a first dielectric constant in the first direction and a second dielectric constant in the second direction, the first dielectric constant greater than the second dielectric constant.

In some example embodiments, the first layer may include a first adhesive layer coupling the sensor layer and the second layer together, and the third layer may include a second adhesive layer coupling the second layer and the fourth layer together.

In some example embodiments, a dielectric constant of the second layer may be greater than a dielectric constant of the first layer, and a dielectric constant of the fourth layer may be greater than the dielectric constant of the first layer.

In some example embodiments, the second layer may comprise a chemically strengthened glass.

In some example embodiments, the fourth layer may comprise a metal oxide.

In some example embodiments, the cover substrate may further comprise at least one additional layer on one or more layers of the first layer, the second layer, the third layer, or the fourth layer.

In some example embodiments, the display layer may include a base layer, a circuit layer on the base layer, a light emitting element layer on the circuit layer, and an encapsulation layer on the light emitting element layer. The sensor layer may be directly on the encapsulation layer.

In some example embodiments, the sensor layer may include a plurality of first electrodes and a plurality of second electrodes. The plurality of second electrodes may intersect the plurality of first electrodes.

Some example embodiments of the inventive concepts provide an electronic device that may include a processor and a display module. The processor may be configured to transmit a control signal and an input image signal. The display module may be configured to display an image in response to the control signal and the input image signal. The display module may include a display layer configured to display the image, a sensor layer on the display layer, and a cover substrate on the sensor layer. The cover substrate may include a first layer on the sensor layer, a second layer on the first layer, a third layer on the second layer, and a fourth layer on the third layer. At least one layer of the first layer, the second layer, the third layer, or the fourth layer may include a material configured to form an electric field based on a first input received at the at least one layer from an input device such that a magnitude of the electric field in a first direction is greater than a magnitude of the electric field in a second direction that intersects the first direction.

In some example embodiments, the at least one layer may have a dielectric anisotropic structure configured to exhibit a first dielectric constant in the first direction and a second dielectric constant in the second direction, the first dielectric constant greater than the second dielectric constant.

In some example embodiments, each layer of the second layer and the fourth layer may be configured to exhibit a dielectric anisotropic structure having a first dielectric constant in the first direction and a second dielectric constant in the second direction, the first dielectric constant greater than the second dielectric constant.

In some example embodiments, the first layer may include a first adhesive layer coupling the sensor layer and the second layer together, and the third layer may include a second adhesive layer coupling the second layer and the fourth layer together.

In some example embodiments, a dielectric constant of the second layer may be greater than a dielectric constant of the first layer, and a dielectric constant of the fourth layer may be greater that the dielectric constant of the first layer.

In some example embodiments, the second layer may comprise a chemically strengthened glass, and the fourth layer may comprise a metal oxide.

In some example embodiments, the cover substrate may further comprise at least one additional layer that is on one or more layers of the first layer, the second layer, the third layer, or the fourth layer.

In some example embodiments, the display layer may include a base layer, a circuit layer on the base layer, a light emitting element layer on the circuit layer, and an encapsulation layer on the light emitting element layer, and the sensor layer may be directly on the encapsulation layer.

In some example embodiments, the sensor layer may include a plurality of first electrodes and a plurality of second electrodes intersecting the plurality of first electrodes.

In some example embodiments, the display module may be configured to transmit a coordinate signal to the processor, the coordinate signal corresponding to sensing signals generated at the sensor layer.

### BRIEF DESCRIPTION OF THE DRAWINGS

FIG. 1 is a block diagram of an electronic device according to some example embodiments of the present inventive concepts.

FIG. 2 is a schematic diagram of an electronic device according to some example embodiments of the present inventive concepts.

FIG. 3 is a block diagram schematically illustrating an electronic device and an input device according to some example embodiments of the present inventive concepts.

FIG. 4A is a cross-sectional view of an electronic device according to some example embodiments of the present inventive concepts.

FIG. 4B is a cross-sectional view of an electronic device according to some example embodiments of the present inventive concepts.

FIG. 5 is a cross-sectional view of an electronic device according to some example embodiments of the present inventive concepts.

FIG. 6 is a block diagram of a display layer and a display driver according to some example embodiments of the present inventive concepts.

FIG. 7 is a block diagram of a sensor layer and a sensor driver according to some example embodiments of the present inventive concepts.

FIGS. 8A and 8B are diagrams illustratively showing signal levels of the sensing signals according to the thickness of the cover substrate disposed on the upper portion of the sensor layer according to some example embodiments of the present inventive concepts.

FIG. 9 illustratively shows a cover substrate according to some example embodiments of the present inventive concepts.

FIGS. 10A, 10B, and 10C illustratively show that a first input from an input device is transferred to the sensor layer through a cover substrate according to some example embodiments of the present inventive concepts.

FIG. 11 is a diagram illustratively showing coordinate accuracy of an electronic device according to some example embodiments of the present inventive concepts.

FIGS. 12A and 12B illustratively show a signal level of sensing signals when a first input from an input device is transferred to a sensor layer according to some example embodiments of the present inventive concepts.

### DETAILED DESCRIPTION

The inventive concepts will now be described more fully hereinafter with reference to the accompanying drawings, in which some example embodiments of the inventive concepts are shown. The inventive concepts may, however, be embodied in different forms and should not be construed as limited to the example embodiments set forth herein. Rather, these example embodiments are provided so that the inventive concepts will be thorough and complete, and will fully convey the scope of the inventive concepts to those skilled in the art.

In this specification, it will be understood that when an element (or a region, a layer, a portion, or the like) is referred to as being “on”, “connected to” or “coupled to” another element, it can be directly disposed on (e.g., in direct contact with), connected to, or coupled to the other element or layer or other elements may be disposed therebetween.

Like reference numerals or symbols refer to like elements throughout. In the drawings, the thickness, ratio, and size of the elements are exaggerated for effectively describing the technical contents. As used herein, the term “and/or” includes any and all combinations of one or more of the associated listed elements.

It will be understood that, although the terms “first”, “second”, etc. may be used herein to describe various elements, the elements are not to be limited by these terms. These terms are only used to distinguish one element from another element. For instance, a first element discussed below could be termed a second element without departing from the scope of the inventive concepts. Similarly, a second element could be termed a first element. In this specification, the singular expressions “a”, “an” and “the” are intended to include the plural forms as well, unless the context clearly indicates otherwise.

In addition, the terms “below”, “under”, “on the lower side”, “above”, “over”, “on the upper side”, or the like may be used to describe the relationships between the elements illustrated in the drawings. These terms are relative concepts and are described on the basis of the directions indicated in the drawings.

It will be further understood that the terms “comprises, includes, has” and/or “comprising, including, having”, when used in this specification, specify the presence of stated features, numbers, steps, operations, elements, components, or combinations thereof, but do not preclude the possibility of the presence or addition of one or more other features, numbers, steps, operations, elements, components, and/or combinations thereof.

Unless otherwise defined, all terms (including technical and scientific terms) used herein have the same meaning as commonly understood by one of ordinary skills in the art to which the inventive concepts belong. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

It will be understood that elements and/or properties thereof (e.g., structures, surfaces, directions, or the like), which may be referred to as being “perpendicular,” “parallel,” or the like with regard to other elements and/or properties thereof (e.g., structures, surfaces, directions, or the like) may be “perpendicular,” “parallel,” or the like or may be “substantially perpendicular,” “substantially parallel,” or the like, respectively, with regard to the other elements and/or properties thereof.

Elements and/or properties thereof (e.g., structures, surfaces, directions, or the like) that are “substantially perpendicular” or “substantially parallel” with regard to other elements and/or properties thereof will be understood to be “perpendicular” or “parallel”, respectively, with regard to the other elements and/or properties thereof within manufacturing tolerances and/or material tolerances and/or have a deviation in magnitude and/or angle from “perpendicular” or “parallel”, respectively, with regard to the other elements and/or properties thereof that is equal to or less than 10% (e.g., a. tolerance of ±10%).

It will be understood that elements and/or properties thereof may be recited herein as being “the same” as other elements and/or properties thereof, and it will be further understood that elements and/or properties thereof recited herein as being “the same” as other elements and/or properties thereof may be “the same” as or “substantially the same” as the other elements and/or properties thereof. Elements and/or properties thereof that are “substantially the same” as other elements and/or properties thereof will be understood to include elements and/or properties thereof that are the same as the other elements and/or properties thereof within manufacturing tolerances and/or material tolerances. Elements and/or properties thereof that are the same or substantially the same as other elements and/or properties thereof may be structurally the same or substantially the same, functionally the same or substantially the same, and/or compositionally the same or substantially the same.

While the term “same” may be used in description of some example embodiments, it should be understood that some imprecisions may exist. Thus, when one element or property is referred to as being the same as another element or property, it should be understood that the element or property is the same as another element or property within a desired manufacturing or operational tolerance range (e.g., ±10%).

It will be understood that elements and/or properties thereof described herein as being “substantially” the same as one or more other elements and/or properties thereof encompasses elements and/or properties thereof that have a relative difference in magnitude with the one or more other elements and/or properties thereof that is equal to or less than 10%. Further, regardless of whether elements and/or properties thereof are modified as “substantially,” it will be understood that these elements and/or properties thereof should be construed as including a manufacturing or operational tolerance (e.g., ±10%) around the stated elements and/or properties thereof.

When the terms “about” or “substantially” are used in this specification in connection with a numerical value, it is intended that the associated numerical value includes a manufacturing or operational tolerance (e.g., ±10%) around the stated numerical value. Moreover, when the words “about” and “substantially” are used in connection with geometric shapes, it is intended that precision of the geometric shape is not required but that latitude for the shape is within the scope of the disclosure. Further, regardless of whether numerical values or shapes are modified as “about” or “substantially,” it will be understood that these values and shapes should be construed as including a manufacturing or operational tolerance (e.g., ±10%) around the stated numerical values or shapes. When ranges are specified, the range includes all values therebetween such as increments of 0.1%.

As described herein, when an operation is described to be performed, or an effect such as a structure is described to be established “by” or “through” performing additional operations, it will be understood that the operation may be performed and/or the effect/structure may be established “based on” the additional operations, which may include performing said additional operations alone or in combination with other further additional operations.

As described herein, an element that is described to be “spaced apart” from another element, in general and/or in a particular direction (e.g., vertically spaced apart, laterally spaced apart, etc.) and/or described to be “separated from” the other element, may be understood to be isolated from direct contact with the other element, in general and/or in the particular direction (e.g., isolated from direct contact with the other element in a vertical direction, isolated from direct contact with the other element in a lateral or horizontal direction, etc.). Similarly, elements that are described to be “spaced apart” from each other, in general and/or in a particular direction (e.g., vertically spaced apart, laterally spaced apart, etc.) and/or are described to be “separated” from each other, may be understood to be isolated from direct contact with each other, in general and/or in the particular direction (e.g., isolated from direct contact with each other in a vertical direction, isolated from direct contact with each other in a lateral or horizontal direction, etc.). Similarly, a structure described herein to be between two other structures to separate the two other structures from each other may be understood to be configured to isolate the two other structures from direct contact with each other.

Hereinafter, some example embodiments of the present inventive concepts will be described with reference to the drawings.

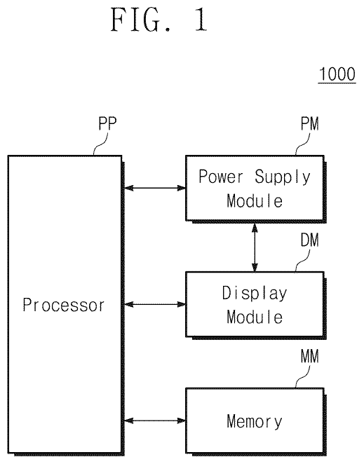

FIG. 1 is a block diagram of an electronic device 1000 according to some example embodiments of the present inventive concepts.

Referring to FIG. 1, an electronic device 1000 according to some example embodiments may include a display module DM, a processor PP, a memory MM, and a power module PM.

The processor PP may include at least one of a central processing unit (CPU), an application processor (AP), a graphic processing unit (GPU), a communication processor (CP), an image signal processor (ISP), or a controller.

The memory MM may store data information necessary for the operation of the processor PP or the display module DM, including for example a program of instructions. The processor PP may execute an application (e.g., a program of instructions) stored in the memory MM to cause an image data signal and/or an input control signal to be transmitted to the display module DM, and the display module DM may process the received signal and output (e.g., transmit) image information through a display screen.

The power module PM may include a power supply module, such as a power adapter or a battery device, and a power conversion module that converts power supplied by the power supply module to generate power required for operation of the electronic device 1000.

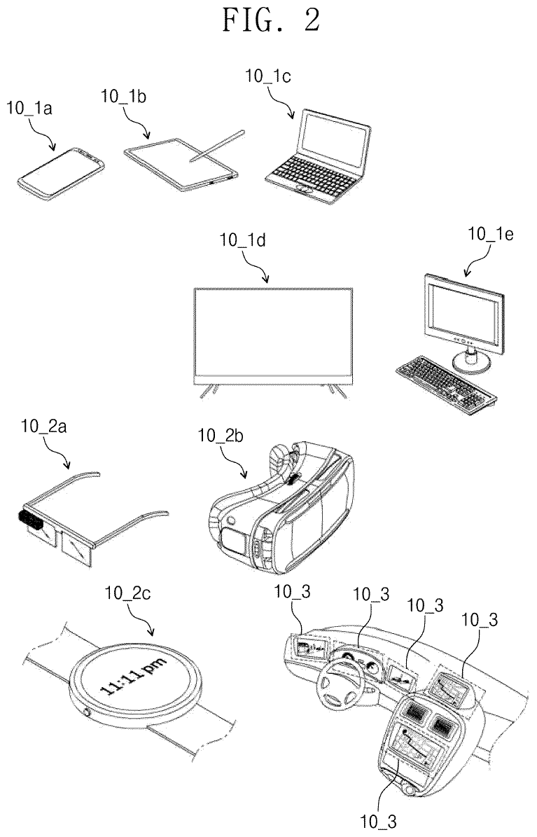

FIG. 2 is a schematic diagram of an electronic device according to some example embodiments of the present inventive concepts.

Referring to FIG. 2, various electronic devices according to embodiments may include an electronic device for displaying an image such as a smartphone 10_1a, a tablet PC 10_1b, a laptop 10_1c, a TV 10_1d, and a desk monitor 10_1e, as well as a wearable electronic device including a display module such as smart glasses 10_2a, a head mounted display 10_2b, a smart watch 10_2c, and the like, an electronic device for a vehicle 10_3 including a display module, such as a CID (Center Information Display), a room mirror display, and the like disposed on an instrument panel, a center fascia, and a dashboard of a vehicle, and the like.

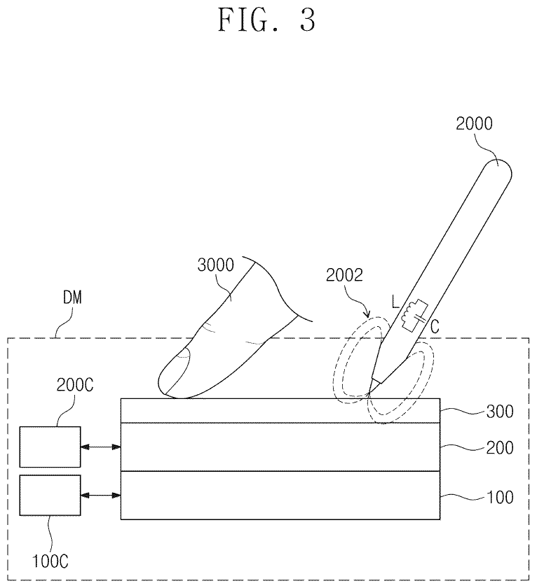

FIG. 3 is a block diagram schematically illustrating a display module DM and an input device according to some example embodiments of the present inventive concepts.

Referring to FIG. 3, the display module DM may include a display layer 100, a sensor layer 200, a cover substrate 300, a display driver 100C, and a sensor driver 200C.

The display layer 100 may be a configuration that is configured to generate or substantially generate an image. The display layer 100 may be a light emitting display layer, and the display layer 100 may, for example, be an organic light emitting display layer, an inorganic light emitting display layer, an organic-inorganic light emitting display layer, a quantum dot display layer, a micro LED display layer, or a nano LED display layer.

The sensor layer 200 may be disposed on (e.g., directly or indirectly on) the display layer 100. The sensor layer 200 may sense an externally applied first input or second input. Each of the first input and the second input may be input means capable of providing a change in capacitance of the sensor layer 200, or may be input means that may cause an induced current in the sensor layer 200. For example, the first input may be an input by an input device 2000 (e.g., an electronic pen) or an input by a Radio Frequency Identification (RFID) tag. For example, the input device 2000 may include a passive type pen or an active type pen. The second input may be a passive type of input means, such as the user's body 3000 (e.g., a finger).

The cover substrate 300 may be disposed on (e.g., directly or indirectly on) the sensor layer 200. The cover substrate 300 may be made of a transparent material capable of transmitting an image therethrough. For example, the cover substrate 300 may include glass, sapphire, plastic, or the like. Although the cover substrate 300 is shown as a single layer in FIG. 3, it is not limited thereto and may include a plurality of layers. The cover substrate 300 may be coupled to the sensor layer 200 through an adhesive layer including an adhesive film or the like. The cover substrate 300 will be described in detail later.

In some example embodiments of the present inventive concepts, the input device 2000 may be a device that generates a magnetic field 2002 of a particular (or, alternatively, predetermined) resonance frequency. The input device 2000 may be configured to transmit an output signal (e.g., an electrical signal which may be referred to herein as a first input) based on an electromagnetic resonance scheme, for example based on interaction between a magnetic field generated at the display module DM (e.g., at the sensor layer 200) with the input device 2000 to induce an electric current in the input device 2000 that is configured to generate an electric signal to the sensor layer 200 using the induced current, and such an electric signal may comprise a first input applied to the display module DM from the input device 2000. The input device 2000 may be referred to as an input pen, a magnetic pen, a stylus pen, an electromagnetic resonance pen, or the like.

The input device 2000 may include an RLC resonant circuit. The RLC resonant circuit may include an inductor L and a capacitor C. In some example embodiments of the present inventive concepts, the RLC resonant circuit may be a variable resonant circuit that varies the resonant frequency. In some example embodiments, the inductor L may be a variable inductor and/or the capacitor C may be a variable capacitor, but is not particularly limited thereto.

The inductor L generates a current in the presence a magnetic field formed in (e.g., generated by) the display module DM, for example, the sensor layer 200. However, the present inventive concepts are not particularly limited thereto. For example, when the input device 2000 operates in an active type, the input device 2000 may generate a current even if it is not provided with a magnetic field from the outside. The generated current is transferred to the capacitor C. The capacitor C charges the current input from the inductor L and discharges the charged current to the inductor L. The inductor L may then emit a magnetic field 2002 of resonant frequency. The emitted magnetic field 2002 may comprise a first input applied from the input device 2000 to the display module DM (e.g., to the sensor layer 200 and/or the cover substrate 300) and may cause an electrical signal to be sensed at the sensor layer 200. An induced current may flow through the sensor layer 200 based on the magnetic field emitted by the input device 2000 which may be applied to the sensor layer 200 and/or the cover substrate 300, and the induced current may be transmitted to the sensor driver 200C as a received signal (or a sensing signal, a signal).

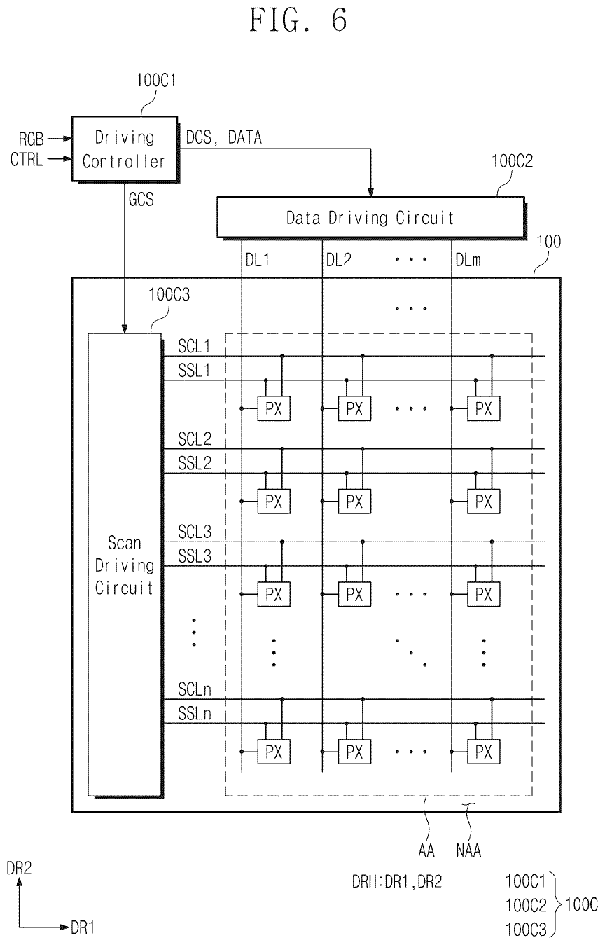

The display driver 100C may drive the display layer 100. In some example embodiments, the display driver 100C may receive the input image signal RGB (see FIG. 6) and the control signal CTRL (see FIG. 6) from the processor PP illustrated in FIG. 1. The control signal CTRL may include various signals. The display driver 100C may generate control signals (e.g., a scan control signal GCS and a data control signal DCS, see FIG. 6) for controlling timing of providing a signal to the display layer 100 based on the control signal CTRL.

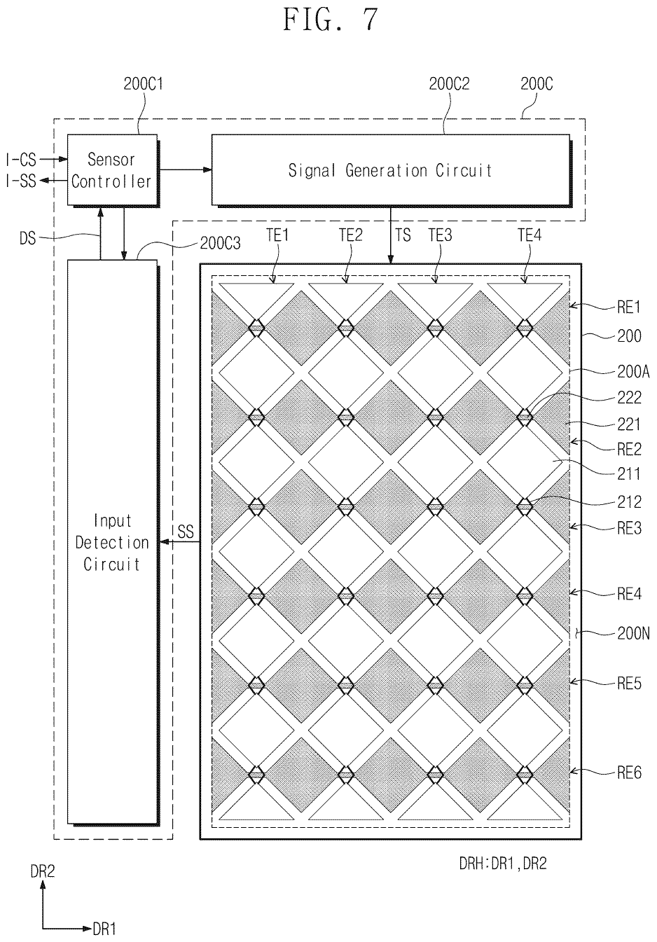

The sensor driver 200C may drive the sensor layer 200. In some example embodiments, the sensor driver 200C may receive the control signal I-CS (see FIG. 7) from the processor PP illustrated in FIG. 1. The control signal I-CS may include a clock signal of the sensor driver 200C. In addition, the control signal I-CS may further include a mode determination signal for determining a driving mode of the sensor driver 200C and the sensor layer 200.

The sensor driver 200C may be implemented as an integrated circuit (IC) to be electrically connected to the sensor layer 200. For example, the sensor driver 200C may be mounted on a separate printed circuit board in a chip on film (COF) manner to be electrically connected to the sensor layer 200.

The sensor driver 200C and the sensor layer 200 may selectively operate in a first mode or a second mode. For example, the first mode may be a mode for sensing an input by the input device 2000, for example, a pen input (e.g., an input caused by a magnetic field generated by the input device 2000). The second mode may be a mode for sensing an input by a user's touch (e.g., an input from a user's body 3000), for example, a touch input. The first mode may be referred to as a pen sensing mode or a first sensing mode, and the second mode may be referred as a touch sensing mode or a second sensing mode.

The transition between the first mode and the second mode may be made in a variety of ways. For example, the sensor driver 200C and the sensor layer 200 may be time-divisionally driven in the first mode and the second mode to sense the first input and the second input. In some example embodiments, switching between the first mode and the second mode may occur by selection of the user or a specific action (or input) of the user, or any one of the first mode and second mode may be activated or deactivated or switched from any one to the other by activation or deactivation of a specific application. In some example embodiments, while the sensor driver 200C and the sensor layer 200 alternately operate in the first mode and the second mode, the first mode may be maintained when a first input is sensed, or the second mode may be maintained when a second input is sensed.

The sensor driver 200C may calculate coordinate information for an input based on a signal received from the sensor layer 200, and provide a coordinate signal I-SS (see FIG. 7) having the coordinate information to the processor PP (see FIG. 1). The processor PP executes an operation corresponding to the user input based on the coordinate signal I-SS. For example, the processor PP may operate the display driver 100C to display a new application image on the display layer 100 based on the coordinate signal I-SS.

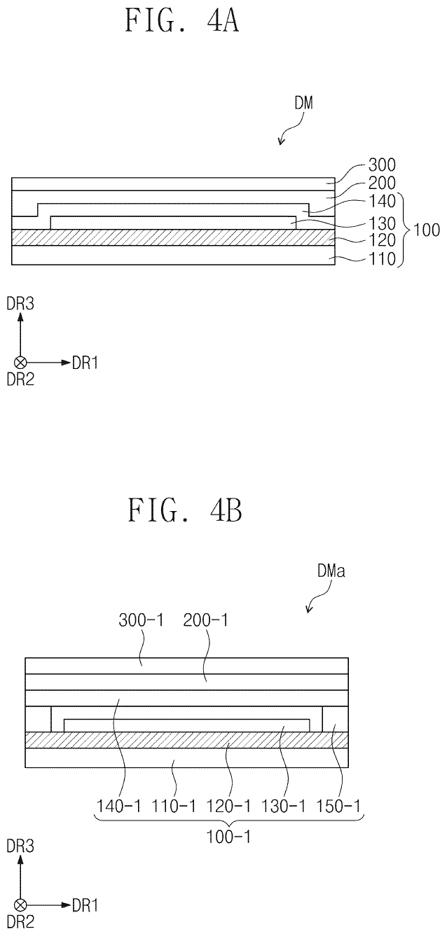

FIG. 4A is a cross-sectional view of a display module DM according to some example embodiments of the present inventive concepts.

Referring to FIG. 4A, a display module DM includes a display layer 100, a sensor layer 200, and a cover substrate 300. The display layer 100 of the display module DM shown in FIG. 4A may be or may be included in the display layer 100 of the display module DM shown in FIG. 3. The sensor layer 200 of the display module DM shown in FIG. 4A may be or may be included in the sensor layer 200 of the display module DM shown in FIG. 3. The cover substrate 300 of the display module DM shown in FIG. 4A may be or may be included in the cover substrate 300 of the display module DM shown in FIG. 3. The display layer 100 may include a base layer 110, a circuit layer 120, a light emitting element layer 130, and an encapsulation layer 140.

The base layer 110 may be a component that provides a base surface on which the circuit layer 120 is disposed. The base layer 110 may be a glass substrate, a metal substrate, or a polymer substrate. However, example embodiments are not limited thereto, and the base layer 110 may be an inorganic layer, an organic layer, or a composite material layer.

The base layer 110 may have a multi-layer structure. For example, the base layer 110 may include a first synthetic resin layer, a silicon oxide (SiOx) layer disposed on the first synthetic resin layer, an amorphous silicon (a-Si) layer disposed on the silicon oxide layer, and a second synthetic resin layer disposed on the amorphous silicon layer. The silicon oxide layer and the amorphous silicon layer may be referred to as a base barrier layer.

The circuit layer 120 may be disposed on the base layer 110. The circuit layer 120 may include an insulating layer, a semiconductor pattern, a conductive pattern, a signal line, and the like. The insulating layer, the semiconductor layer, and the conductive layer are formed over the base layer 110 by coating, vapor deposition, or the like, and then the insulating layer, the semiconductor layer, and the conductive layer may be selectively patterned through a plurality of photolithography processes. Thereafter, the semiconductor pattern, the conductive pattern, and the signal line included in the circuit layer 120 may be formed.

The light emitting element layer 130 may be disposed on the circuit layer 120. The light emitting element layer 130 may include a light emitting element. For example, the light emitting element layer 130 may include an organic light emitting material, an inorganic light emitting material, an organic-inorganic light emitting material, a quantum dot, a quantum rod, a micro-LED, or a nano LED.

The encapsulation layer 140 may be disposed on the light emitting element layer 130. The encapsulation layer 140 may protect the light emitting element layer 130 from foreign substances such as moisture, oxygen, and dust particles.

The sensor layer 200 may be formed over the display layer 100 through a process continuous with the display layer 100. In some example embodiments, it may be expressed that the sensor layer 200 is disposed directly on the display layer 100. “Directly disposed” may mean that a third component is not disposed between the sensor layer 200 and the display layer 100. That is, an additional adhesive component may not be disposed between the sensor layer 200 and the display layer 100. In some example embodiments, the sensor layer 200 may be coupled to the display layer 100 through an adhesive component. The adhesive component may include a conventional adhesive or tackifier.

The cover substrate 300 is disposed on the sensor layer 200. The cover substrate 300 may be coupled to the sensor layer 200 via an adhesive component. The adhesive component may include a conventional adhesive or tackifier.

FIG. 4B is a cross-sectional view of a display module DMa according to some example embodiments of the present inventive concepts.

Referring to FIG. 4B, the display module DMa may include a display layer 100-1, a sensor layer 200-1, and a cover substrate 300-1. The display layer 100-1 of the display module DM shown in FIG. 4B may be or may be included in the display layer 100 of the display module DM shown in FIG. 3. The sensor layer 200-1 of the display module DM shown in FIG. 4B may be or may be included in the sensor layer 200 of the display module DM shown in FIG. 3. The cover substrate 300-1 of the display module DM shown in FIG. 4B may be or may be included in the cover substrate 300 of the display module DM shown in FIG. 3. The display layer 100-1 may include a base layer 110-1, a circuit layer 120-1, a light emitting element layer 130-1, an encapsulation substrate 140-1, and a coupling component 150-1.

Each of the base layer 110-1 and the encapsulation substrate 140-1 may be a glass substrate, a metal substrate, a polymer substrate, or the like, but are not particularly limited thereto.

The coupling component 150-1 may be disposed between the base layer 110-1 and the encapsulation substrate 140-1. The coupling component 150-1 may couple the encapsulation substrate 140-1 to the base layer 110-1 or the circuit layer 120-1. The coupling component 150-1 may include an inorganic substance or an organic substance. For example, the inorganic material may include a frit seal, and the organic material may include a photocurable resin or a photoplastic resin. However, the material constituting the coupling component 150-1 is not limited to the above example.

The sensor layer 200-1 may be disposed directly on the encapsulation substrate 140-1. “Directly disposed” may mean that the third component is not disposed between the sensor layer 200-1 and the encapsulation substrate 140-1. That is, a separate adhesive component may not be disposed between the sensor layer 200-1 and the display layer 100-1. However, the present inventive concepts are not limited thereto, and an adhesive layer may be further disposed between the sensor layer 200-1 and the encapsulation substrate 140-1.

The cover substrate 300-1 is disposed on the sensor layer 200-1. The cover substrate 300-1 may be coupled to the sensor layer 200-1 through an adhesive component. The adhesive component may include a conventional adhesive or tackifier.

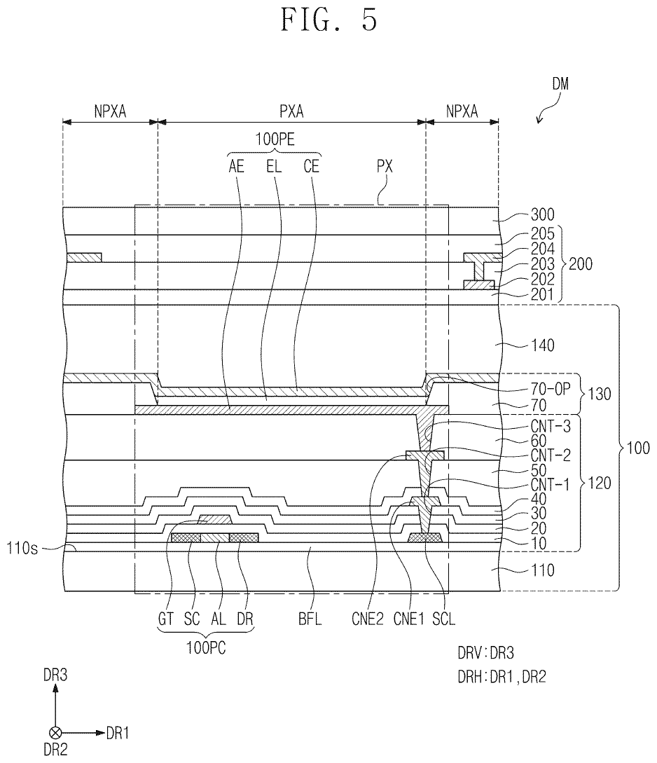

FIG. 5 is a cross-sectional view of a display module DM according to some example embodiments of the present inventive concepts. In describing FIG. 5, components described with reference to FIG. 4A are denoted by the same reference numerals, and description thereof is omitted.

Referring to FIG. 5, at least one inorganic layer may be formed on an upper surface of the base layer 110. The inorganic layer may include at least one of aluminum oxide, titanium oxide, silicon oxide, silicon oxynitride, zirconium oxide, or hafnium oxide. The inorganic layer may include multiple layers. The multiple inorganic layers may constitute a barrier layer and/or a buffer layer. In some example embodiments, including the example embodiments shown in FIG. 5, the display layer 100 includes a buffer layer BFL.

The buffer layer BFL may improve a coupling force between the base layer 110 and semiconductor pattern(s), for example semiconductor patterns SC, AL, DR, and SCL as shown in FIG. 5. The buffer layer BFL may include a silicon oxide layer and a silicon nitride layer, and the silicon oxide layer and the silicon nitride layer may be alternately stacked.

The semiconductor patterns SC, AL, DR, and SCL may be disposed on the buffer layer BFL. Each of the semiconductor patterns SC, AL, DR, and SCL may include polysilicon. However, without being limited thereto, each of the semiconductor patterns SC, AL, DR, and SCL may include amorphous silicon, low-temperature polycrystalline silicon, or an oxide semiconductor.

FIG. 5 illustrates some semiconductor patterns SC, AL, DR, and SCL, and other semiconductor patterns may be further disposed in other regions. The display module DM may comprise a plurality of pixels, and the semiconductor patterns SC, AL, DR, and SCL may be arranged in a particular rule across the plurality of pixels of the display module. The semiconductor patterns SC, AL, DR, and SCL may have different electrical properties depending on whether they are doped or not. The semiconductor patterns SC, AL, DR, and SCL may include a first region SC, DR, and SCL having a high conductivity and a second region AL having a low conductivity. The first region SC, DR, and SCL may be doped with N-type dopant or P-type dopant. A P-type transistor may include a doped region doped with a P-type dopant, and an N-type transistor may include a doped region doped with an N-type dopant. The second region AL may be an undoped region or may be doped at a lower concentration than the first region SC, DR, and SCL.

The conductivity of the first region SC, DR, and SCL is greater than that of the second region AL, and may serve or substantially serve as electrodes or signal lines. The second region AL may correspond or substantially correspond to an active region (or channel) of the transistor. In other words, a portion (e.g., the second region AL) of the semiconductor patterns SC, AL, DR, and SCL may be the active region AL of the transistor 100PC, another portion (e. g., the first regions SC and DR) may be the source region SC or the drain region DR of the transistor 100PC, and another portion (e.g., the first region SCL) may be the connection electrode or the connection signal line SCL.

In example embodiments where the display module DM includes a plurality of pixels PX, each pixel PX of the plurality of pixels PX may include an equivalent circuit including a plurality of transistors, at least one capacitor, and at least one light emitting element, and the equivalent circuit of the pixel may be modified into various forms. In FIG. 5, one transistor 100PC and a light emitting element 100PE included in a pixel PX of a plurality of pixels PX of the display module DM are illustratively illustrated.

The source region SC, the active region AL, and the drain region DR of the transistor 100PC may be formed from the semiconductor patterns SC, AL, DR, and SCL. The source region SC and the drain region DR may extend in opposite directions from the active region AL in a cross-section. FIG. 5 illustrates a portion of a connection signal line SCL formed from semiconductor patterns SC, AL, DR, and SCL. Although not shown separately, the connection signal line SCL may be connected to the drain region DR of the transistor 100PC in a plane (e.g., a horizontal plane extending in a horizontal direction DRH parallel to an upper surface 110s of the base layer 110).

A first insulating layer 10 may be disposed on the buffer layer BFL. The first insulating layer 10 may overlap a plurality of pixels of the display module DM in common and cover the semiconductor patterns SC, AL, DR, and SCL, for example such that the plurality of pixels PX may include separate portions of a single first insulating layer 10, for example such that separate portions of a single unitary piece of material that at least partially defines the single first insulating layer 10 are included in separate pixels PX of the plurality of pixels PX of the display module DM. The first insulating layer 10 may be an inorganic layer and/or an organic layer, and may have a single-layer or a multi-layer structure. The first insulating layer 10 may include at least one of aluminum oxide, titanium oxide, silicon oxide, silicon nitride, silicon oxynitride, zirconium oxide, or hafnium oxide. In some example embodiments, the first insulating layer 10 may be a single-layer silicon oxide layer. The first insulating layer 10 as well as the insulating layer of the circuit layer 120 described later may be an inorganic layer and/or an organic layer, and may have a single-layer or a multi-layer structure. The inorganic layer may include, but is not limited to, at least one of the materials described above.

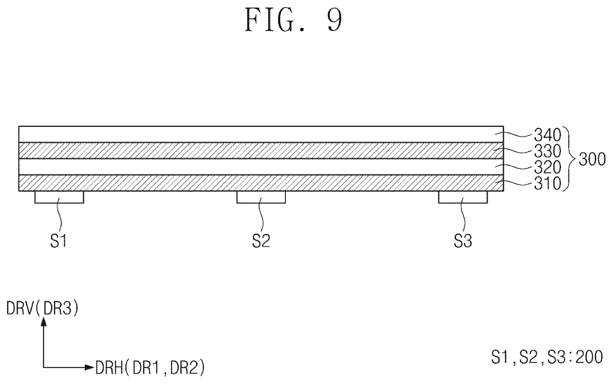

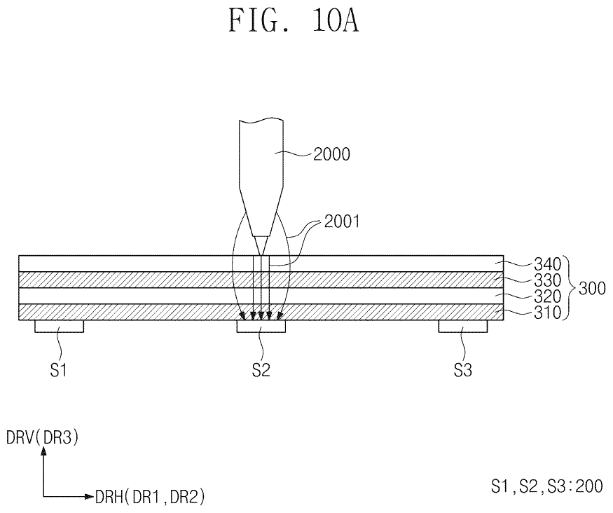

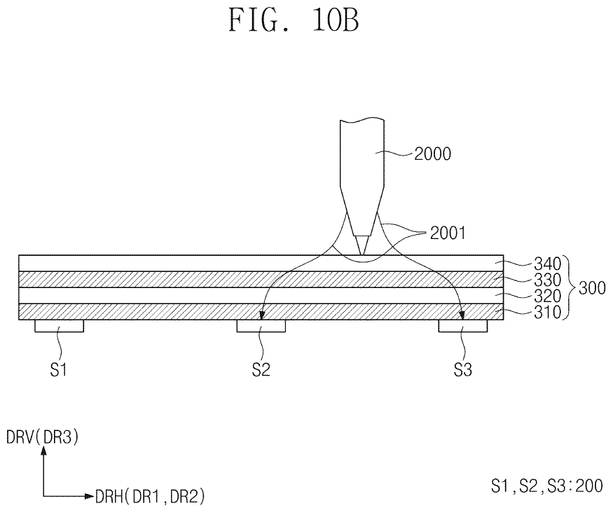

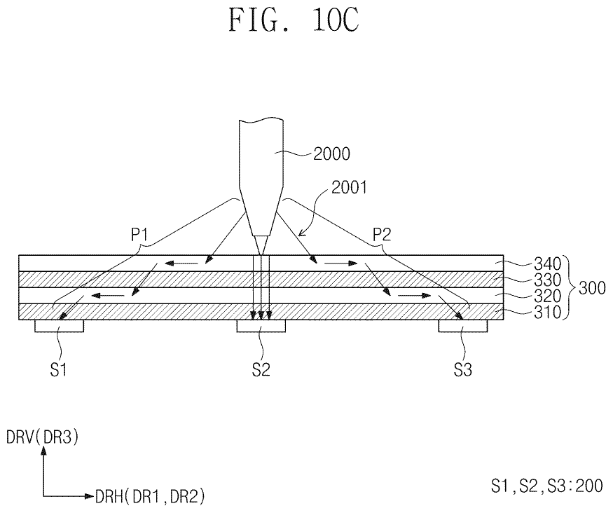

A gate GT of the transistor 100PC is disposed on the first insulating layer 10. The gate GT may be a part of a metal pattern. The gate GT overlaps the active region AL (e.g., overlaps in a vertical direction DRV perpendicular to an upper surface 110s of the base layer 110). In the process of doping or reducing the semiconductor patterns SC, AL, DR, and SCL, the gate GT may function as a mask. As shown in FIG. 5, a horizontal direction DRH may include one or both of first and second directions DR1 and DR2 that are parallel to the upper surface 110s of the base layer 110 and are perpendicular with each other, and a vertical direction DRV may include a third direction DR3 that is perpendicular to the upper surface 110s of the base layer 110 and thus is perpendicular to both the first and second directions DR1 and DR2. As described herein, the horizontal direction DRH (including the first and second directions DR1 and DR2) may be an in-plane direction of a plane in which one or more layers of the display module DM extend (e.g., one or more layers of the display layer 100 and/or sensor layer 200 as shown in FIG. 5, one or more layers 310 to 340 of the cover substrate 300 as shown in FIGS. 9 and 10A to 10C, or any combination thereof), while the vertical direction DRV may be perpendicular to such in-plane direction. The horizontal direction DRH as described herein will be understood to include one or more of the first and/or second directions DR1 and/or DR2.

A second insulating layer 20 is disposed on the first insulating layer 10 and may cover the gate GT. The second insulating layer 20 may overlap the pixels in common, for example such that the plurality of pixels PX may include separate portions of a single second insulating layer 20, for example such that separate portions of a single unitary piece of material that at least partially defines the single second insulating layer 20 are included in separate pixels PX of the plurality of pixels PX of the display module DM. The second insulating layer 20 may be an inorganic layer and/or an organic layer, and may have a single-layer or a multi-layer structure. The second insulating layer 20 may include at least one of silicon oxide, silicon nitride, or silicon oxynitride. In some example embodiments, the second insulating layer 20 may have a multi-layer structure including a silicon oxide layer and a silicon nitride layer.

A third insulating layer 30 may be disposed on the second insulating layer 20. The third insulating layer 30 may have a single-layer or a multi-layer structure. The third insulating layer 30 may include at least one of a silicon oxide layer or a silicon nitride layer. For example, the third insulating layer 30 may have the multi-layer structure including both a silicon oxide layer and a silicon nitride layer, although example embodiments are not limited thereto. In some example embodiments, the third insulating layer 30 may be a single-layer silicon oxide layer or silicon nitride layer.

A first connection electrode CNE1 may be disposed on the third insulating layer 30. The first connection electrode CNE1 may be connected to the connection signal line SCL through a contact hole CNT-1 penetrating the first, second, and third insulating layers 10, 20, and 30.

A fourth insulating layer 40 may be disposed on the third insulating layer 30. The fourth insulating layer 40 may be a single-layer silicon oxide layer. A fifth insulating layer 50 may be disposed on the fourth insulating layer 40. The fifth insulating layer 50 may be an organic layer. The organic layer may include, but is not limited to, an acrylic-based organic layer. The organic layer may include an epoxy resin, an acrylic resin, or an imide-based resin. The organic layer may include at least one of an acrylic resin, a methacrylic resin, polyisoprene, a vinyl resin, an epoxy resin, a urethane resin, a cellulose resin, a siloxane resin, a polyimide resin, a polyamide resin, or a perylene resin.

A second connection electrode CNE2 may be disposed on the fifth insulating layer 50. The second connection electrode CNE2 may be connected to the first connection electrode CNE1 through a contact hole CNT-2 penetrating the fourth insulating layer 40 and the fifth insulating layer 50.

A sixth insulating layer 60 is disposed on the fifth insulating layer 50 and may cover the second connection electrode CNE2. The sixth insulating layer 60 may be an organic layer. The organic layer may include, but is not limited to, an acrylic-based organic layer. The organic layer may include an epoxy resin, an acrylic resin, or an imide-based resin. The organic layer may include at least one of an acrylic resin, a methacrylic resin, polyisoprene, a vinyl resin, an epoxy resin, a urethane resin, a cellulose resin, a siloxane resin, a polyimide resin, a polyamide resin, or a perylene resin.

The light emitting element layer 130 may be disposed on the circuit layer 120. The light emitting element layer 130 may include the light emitting element 100PE. For example, the light emitting element layer 130 may include an organic light emitting material, an inorganic light emitting material, an organic-inorganic light emitting material, a quantum dot, a quantum rod, a micro LED, or a nano LED. Hereinafter, the light emitting element 100PE will be described by taking the organic light emitting element as an example, but the present inventive concepts are not particularly limited thereto.

The light emitting element 100PE may include a first electrode AE, a light emitting layer EL, and a second electrode CE. The first electrode AE may be disposed on the sixth insulating layer 60. The first electrode AE may be connected to the second connection electrode CNE2 through a contact hole CNT-3 penetrating the sixth insulating layer 60.

A pixel defining film 70 is disposed on the sixth insulating layer 60, and may cover a portion of the first electrode AE. An opening 70-OP is defined in the pixel defining film 70. The opening 70-OP of the pixel defining film 70 exposes at least a portion of the first electrode AE. The pixel defining film 70 may include at least one of an inorganic layer or an organic layer. The inorganic layer may include a silicon nitride layer, a silicon oxynitride layer, a silicon oxide layer, a titanium oxide layer, an aluminum oxide layer, or the like. The organic layer may include, but is not limited to, an acrylic-based organic layer. The organic layer may include an epoxy resin, an acrylic resin, or an imide-based resin. The organic layer may include at least one of an acrylic resin, a methacrylic resin, polyisoprene, a vinyl resin, an epoxy resin, a urethane resin, a cellulose resin, a siloxane resin, a polyimide resin, a polyamide resin, or a perylene resin.

An effective area AA (see FIG. 6) may include a light emitting area PXA and a non-light emitting area NPXA adjacent to the light emitting area PXA. The non-light emitting area NPXA may surround the light emitting area PXA. In some example embodiments, the light emitting area PXA is defined to correspond to a partial region of the first electrode AE exposed by the opening 70-OP. The effective area AA may include a plurality of light emitting areas PXA corresponding to separate openings 70-OP, and each light emitting area PXA may be included in a separate pixel PX of a plurality of pixels PX in the display module DM. As shown, in some example embodiments, each first electrode AE may at least partially define horizontal boundaries (in a horizontal plane extending in one or more horizontal directions DRH parallel to the upper surface 110s of the base layer 110) of a separate pixel PX of a plurality of pixels PX in the display module DM (said pixel PX may be defined to extend vertically through at least an entirety of a thickness of the display module DM in a vertical direction DRV perpendicular to the upper surface 110s of the base layer 110). However, example embodiments are not limited thereto, and in some example embodiments each separate light emitting area PXA and/or opening 70-OP may at least partially define horizontal boundaries (in a horizontal plane extending in one or more horizontal directions DRH parallel to the upper surface 110s of the base layer 110) of a separate pixel PX of a plurality of pixels PX in the display module DM (said pixel PX may be defined to extend vertically through at least an entirety of a thickness of the display module in a vertical direction DRV perpendicular to the upper surface 110s of the base layer 110).

The light emitting layer EL may be disposed on the first electrode AE. The light emitting layer EL may be disposed in a region corresponding to the opening 70-OP. Although FIG. 5 illustrates an example in which the light emitting layer EL is disposed in the opening 70-OP, the present inventive concepts are not particularly limited thereto. For example, the light emitting layer EL may extend to cover a portion of a side surface of the pixel defining film 70 defining the opening 70-OP and a top surface of the pixel definition film 70.

In some example embodiments of the present inventive concepts, the light emitting layer EL may be formed separately in each pixel PX of the plurality of pixels PX of the display module DM. When the light emitting layer EL is formed to be separated from each of the pixels PX, each of the light emitting layers EL may emit light of at least one color of blue, red, or green wavelength spectra. However, the present inventive concepts are not limited thereto, and the light emitting layer EL may be connected to pixels PX and commonly included in the plurality of pixels PX, for example such that the plurality of pixels PX may include separate portions of a single light emitting layer EL, for example such that separate portions of a single unitary piece of material that at least partially defines the single light emitting layer EL are included in separate pixels PX of the plurality of pixels PX of the display module DM. In some example embodiments, the light emitting layer EL may provide (e.g., emit) blue light or white light.

The second electrode CE may be disposed on the light emitting layer EL. The second electrode CE has an integral shape and may be commonly included in a plurality of pixels, for example such that the plurality of pixels PX may include separate portions of a single second electrode CE, for example such that separate portions of a single unitary piece of material that at least partially defines the single second electrode CE are included in separate pixels PX of the plurality of pixels PX of the display module DM.

In some example embodiments of the present inventive concepts, a hole control layer may be disposed between the first electrode AE and the light emitting layer EL. The hole control layer may be disposed in common in the light emitting area PXA and the non-light emitting area NPXA. The hole control layer includes a hole transport layer, and may further include a hole injection layer. An electronic control layer may be disposed between the light emitting layer EL and the second electrode CE. The electron control layer includes an electron transport layer, and may further include an electron injection layer. The hole control layer and the electron control layer may be commonly formed In a plurality of pixels using an open mask or an inkjet process.

The encapsulation layer 140 may be disposed on the light emitting element layer 130. The encapsulation layer 140 may include an inorganic layer, an organic layer, and an inorganic layer sequentially stacked, but the layers constituting the encapsulation layer 140 are not limited thereto. The inorganic layers protect the light emitting element layer 130 from moisture and oxygen, and the organic layer may protect the light emitting element layer 130 from foreign substances such as dust particles. The inorganic layers may include a silicon nitride layer, a silicon oxynitride layer, a silicon oxide layer, a titanium oxide layer, an aluminum oxide layer, or the like. The organic layer may include, but is not limited to, an acrylic-based organic layer.

The sensor layer 200 may include a base insulating layer 201, a first conductive layer 202, an intermediate insulating layer 203, a second conductive layer 204, and a cover insulating layer 205.

The base insulating layer 201 may be an inorganic layer including at least any one of silicon nitride, silicon oxynitride, or silicon oxide. In some example embodiments, the base insulating layer 201 may be an organic layer including an epoxy resin, an acrylic resin, or an imide-based resin. The base insulating layer 201 may have a single-layer structure or a multi-layer structure stacked along the vertical direction DRV (e.g., the third direction DR3).

Each of the first conductive layer 202 and the second conductive layer 204 may have a single-layer structure or a multi-layer structure stacked along the vertical direction DRV (e.g., the third direction DR3).

Each of the first conductive layer 202 and the second conductive layer 204 having a single-layer structure may include a metal layer or a transparent conductive layer. The metal layer may include molybdenum, silver, titanium, copper, aluminum, or an alloy thereof. The transparent conductive layer may include a transparent conductive oxide such as indium tin oxide (ITO), indium zinc oxide (IZO), zinc oxide (ZnO), indium zinc tin oxide (IZTO), or the like. In addition, the transparent conductive layer may include a conductive polymer such as poly(3,4-ethylenedioxythiophene) (PEDOT), a metal nanowire, a graphene, or the like.

Each of the first conductive layer 202 and the second conductive layer 204 of the multi-layer structure may include metal layers. The metal layers may have, for example, a three-layer structure of titanium/aluminum/titanium. The conductive layer of the multi-layer structure may include at least one metal layer and at least one transparent conductive layer.

In some example embodiments of the present inventive concepts, a thickness of the first conductive layer 202 (e.g., in a vertical direction DRV, for example in the third direction DR3) may be greater than or equal to that of the second conductive layer 204. When the thickness of the first conductive layer 202 is greater than that of the second conductive layer 204, resistance of components (e.g., an electrode, a sensing pattern, a bridge pattern, or the like) included in the first conductive layer 202 may be reduced. In addition, since the first conductive layer 202 is disposed below the second conductive layer 204, the probability that components included in the first conductive layer 202 are visually recognized by external light reflection may be lower than that of the second conductive layer 204 even when the thickness of the first conductive layer 202 is increased.

At least one of the intermediate insulating layer 203 or the cover insulating layer 205 may include an inorganic film. The inorganic film may include at least one of aluminum oxide, titanium oxide, silicon oxide, silicon nitride, silicon oxynitride, zirconium oxide, or hafnium oxide.

At least one of the intermediate insulating layer 203 or the cover insulating layer 205 may include an organic film. The organic film may include at least one of an acrylic resin, a methacrylic resin, polyisoprene, a vinyl resin, an epoxy resin, a urethane resin, a cellulose resin, a siloxane resin, a polyimide resin, a polyamide resin, or a perylene resin.

Although the sensor layer 200 includes the first conductive layer 202 and the second conductive layer 204, that is, a total of two conductive layers, which has been described above as an example, the present inventive concepts are not particularly limited thereto. For example, the sensor layer 200 may include three or more conductive layers.

The cover substrate 300 is disposed on the sensor layer 200. The cover substrate 300 may be coupled to the sensor layer 200 via an adhesive component. The adhesive component may include a conventional adhesive or tackifier.

FIG. 6 is a block diagram of a display layer 100 and a display driver 100C according to some example embodiments of the present inventive concepts.

Referring to FIG. 6, the display driver 100C includes a driving controller 100C1, a data driving circuit 100C2, and a scan driving circuit 100C3.

The display layer 100 may include driving scan lines SCL1, SCL2, SCL3, . . . , and SCLn, sensing scan lines SSL1, SSL2, SSL3, . . . , and SSLn, data lines DL1, DL2, . . . , and DLm, and pixels PX. Here, each of n and m is independently an integer greater than or equal to 1. The display layer 100 may be divided into an active area AA and an inactive area NAA. The pixels PX may be disposed in the effective area AA of the display layer 100, and the scan driving circuit 100C3 may be disposed in the ineffective area NAA of the display layer 100.

The driving scan lines SCL1, SCL2, SCL3, . . . , and SCLn and the sensing scan lines SSL1, SSL2, SSL3, . . . , and SSLn extend parallel to the first direction DR1 and are arranged spaced apart from each other in the second direction DR2. The second direction DR2 may be a direction intersecting the first direction DR1. The data lines DL1, DL2, . . . , and DLm extend parallel to the second direction DR2, and are arranged spaced apart from each other in the first direction DR1.

The plurality of pixels PX are electrically connected to the driving scan lines SCL1, SCL2, SCL3, . . . , and SCLn, the sensing scan lines SSL1, SSL2, SSL3, . . . , and SSLn, and the data lines DL1, DL2, . . . , and DLm, respectively. Each of the plurality of pixels PX may be electrically connected to two scan lines. However, the number (quantity) of scan lines connected to each pixel PX is not limited thereto. For example, one or three scan lines may be electrically connected to each pixel PX. The display layer 100 extends in the second direction DR2 and may further include lead-out lines (or referred to as sensing lines) arranged in the first direction DR1. In some example embodiments, the plurality of pixels PX may be connected to the readout lines.

Each pixel PX of the plurality of pixels PX includes a light emitting element and a pixel circuit that controls light emission of the light emitting element. The light emitting element may include an organic light emitting diode, an inorganic light emitting diode, a micro LED, or a nano LED. The pixel circuit may include a plurality of transistors and at least one capacitor.

The driving controller 100C1 may receive the input image signal RGB and the control signal CTRL from the processor PP (see FIG. 1). The driving controller 100C1 may generate the image data DATA by converting the input image signal RGB.

The driving controller 100C1 may generate a scan control signal GCS and a data control signal DCS based on the control signal CTRL. The data driving circuit 100C2 may receive the data control signal DCS and the image data DATA from the driving controller 100C1. The data driving circuit 100C2 may convert the image data DATA into data voltages (or referred to as data signals) in response to the data control signal DCS. The data driving circuit 100C2 may output (transmit) data voltages to the plurality of data lines DL1, DL2, . . . , and DLm. The data voltages may be analog voltages corresponding to a grayscale value of the image data DATA.

In some example embodiments, the data driving circuit 100C2 may be further connected to a plurality of read-out lines. In some example embodiments, the data driving circuit 100C2 may further receive a sensing control signal from the driving controller 100C1, and may sense characteristics of elements included in each pixel PX of the display layer 100 in response to the sensing control signal.

As an example of the present inventive concepts, the data driving circuit 100C2 may be implemented in one chip (or an integrated circuit). The data driving circuit 100C2 may be disposed in the non-effective area NAA of the display layer 100, but example embodiments are not limited thereto. For example, the data driving circuit 100C2 may be mounted on a circuit film connected to the display layer 100.

The scan driving circuit 100C3 may receive the scan control signal GCS from the driving controller 100C1. The scan driving circuit 100C3 may output (transmit) scan signals in response to the scan control signal GCS. The scan driving circuit 100C3 may be embedded in the display layer 100. When the scan driving circuit 100C3 is embedded in the display layer 100, the scan driving circuit 100C3 may include transistors formed through the same process as the pixel circuit portion of each pixel PX. The scan driving circuit 100C3 may be disposed in the non-effective area NAA of the display layer 100, but the present inventive concepts are not limited thereto. In some example embodiments, at least a part of the scan driving circuit 100C3 may overlap the effective area AA of the display layer 100 (e.g., overlap in a vertical direction DRV perpendicular to both the first and second directions DR1 and DR2).

The scan driving circuit 100C3 may generate a plurality of driving scan signals and a plurality of sensing scan signals in response to the scan control signal GCS. The plurality of driving scan signals may be applied to the driving scan lines SCL1, SCL2, SCL3, ..., and SCLn, and the plurality of sensing scan signals may be applied to the sensing scan lines SSL1, SSL2, SSL3, . . . , and SSLn.

FIG. 7 is a block diagram of a sensor layer 200 and a sensor driver 200C according to some example embodiments of the present inventive concepts.

Referring to FIG. 7, an effective sensing region 200A and an ineffective sensing region 200N may be defined in the sensor layer 200. The effective sensing region 200A may be a region that is configured to be activated according to an electrical signal. For example, the effective sensing region 200A may be a region that is configured to sense an input, which may include an electrical signal. The effective sensing region 200A may overlap the active area AA (see FIG. 6) of the display layer 100 (see FIG. 5) (e.g., overlap in a direction perpendicular to both the first and second directions DR1 and DR2). The ineffective sensing region 200N may surround the effective sensing region 200A. The ineffective sensing region 200N may be a region that does not sense an input (e.g., does not sense any input from any input device 2000 or body 3000). The ineffective sensing region 200N may overlap the inactive area NAA (see FIG. 6) of the display layer 100 (see FIG. 6) (e.g., overlap in a direction perpendicular to both the first and second directions DR1 and DR2).

The sensor layer 200 may include a plurality of first electrodes TE1, TE2, TE3, and TE4 (or referred to as transmission electrodes and/or transfer electrodes) and a plurality of second electrodes RE1, RE2, RE3, RE4, RE5, and RE6 (or referred to as receiving electrodes). Each of the plurality of first electrodes TE1 to TE4 extends along a second direction DR2, and the plurality of first electrode TE1 to TE4 may be arranged to be spaced apart from each other in a first direction DR1. Each of the plurality of second electrodes RE1 to RE6 extends along the first direction DR1, and the plurality of second electrode RE1 to RE6 may be arranged to be spaced apart from each other in the second direction DR2.

The sensor layer 200 may further include a plurality of first signal wirings (or first trace wirings) connected to the plurality of first electrodes TE1 to TE4 and a plurality of second signal wirings (or second trace wirings) coupled to the plurality of second electrodes RE1 to RE6.

Each of the plurality of first electrodes TE1 to TE4 may include a first sensing portion 211 and a bridge portion 212. The two first sensing portions 211 adjacent to each other may be electrically connected to each other by the bridge portion 212, but are not particularly limited thereto. The first sensing portion 211 and the bridge portion 212 may be disposed on different layers and may be at least partially offset from each other in a vertical direction (DRV) extending perpendicular to the first and second directions DR1 and DR2.

Each of the plurality of second electrodes RE1 to RE6 may include a second sensing portion 221 and a connecting portion 222. The second sensing portion 221 and the connecting portion 222 may be in one body (e.g., separate portions of a single unitary piece of material) and may be disposed at a same layer. Each of the plurality of first electrodes TE1 to TE4 may have a mesh shape, and each of the plurality of second electrodes RE1 to RE6 may have a mesh shape.

The first and second sensing portions 211, 221, the bridge portion 212, and the connecting portion 222 may include a metal layer. Each of the first and second sensing portions 211, 221, the bridge portion 212, and the connecting portion 222 may have a mesh shape.

The sensor driver 200C may receive the control signal I-CS from the processor PP (see FIG. 1) and provide the coordinate signal I-SS to the processor PP (FIG. 1).

The sensor driver 200C may include a sensor controller 200C1, a signal generation circuit 200C2, and an input detection circuit 200C3. The sensor controller 200C1, the signal generation circuit 200C2, and the input detection circuit 200C3 may be implemented in a single chip, or some of the sensor controller 200C1 and the signal generation circuit 200C2 and the input detection circuit 200C3, and another part thereof may be implemented in different chips from each other.

The sensor controller 200C1 may control operations of the signal generation circuit 200C2, calculate coordinates of an external input from a sensing signal SS received from the input detection circuit 200C3, analyze information transmitted from the input device 2000 (see FIG. 3) from a modulation signal received from the input detection circuit 200C3, or perform any combination thereof.

The signal generation circuit 200C2 may output (transmit) the output signals TS (or transmission signals) to the sensor layer 200, for example, the first electrodes TE1 to TE4. The signal generation circuit 200C2 may output (transmit) the output signal TS coinciding with the operation mode to the sensor layer 200.

The input detection circuit 200C3 may receive the sensing signals SS from the sensor layer 200, for example, the second electrodes RE1 to RE6. The input detection circuit 200C3 may convert an analog signal (e.g., a sensing signal SS) into a digital signal DS. For example, the input detection circuit 200C3 may amplify and then filter the received sensing signals SS of analog form, and convert the filtered signal into a digital signal DS. The input detection circuit 200C3 may output (transmit) the digital signal DS to the sensor controller 200C1.

The sensor controller 200C1 may generate the coordinate signal I-SS based on the digital signal DS received from the input detection circuit 200C3. Specifically, the sensor controller 200C1 may generate the coordinate signal I-SS using the digital signal DS.

The sensor controller 200C1 may determine an operation mode based on the digital signal DS received from the input detection circuit 200C3. In some example embodiments, the sensor controller 200C1 may determine the operation mode to be any one of a touch sensing mode or a pen sensing mode.

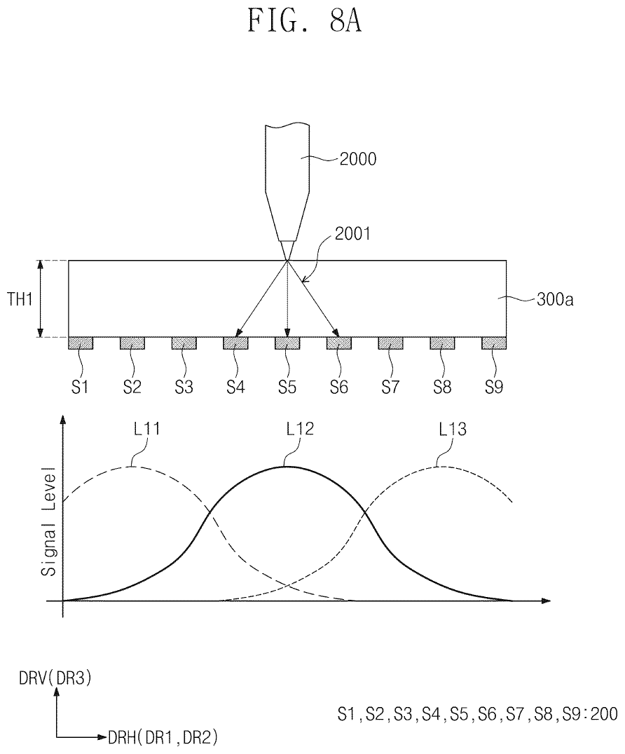

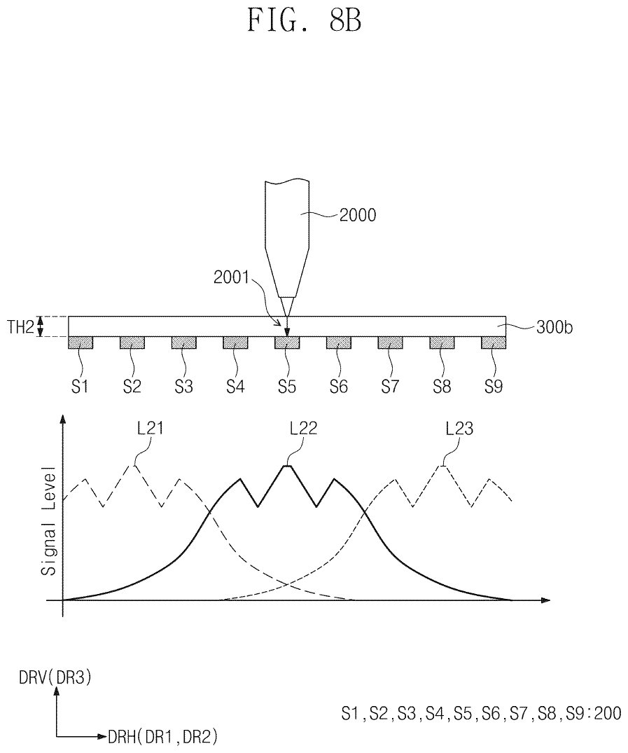

FIGS. 8A and 8B are diagrams illustratively showing signal levels of the sensing signals according to the thickness of the cover substrate disposed on the sensor layer 200 according to some example embodiments of the present inventive concepts.

Referring to FIGS. 7, 8A, and 8B, the sensor layer 200 includes sensor electrodes S1, S2, S3, S4, S5, S6, S7, S8, and S9. The sensor electrodes S1, S2, S3, S4, S5, S6, S7, S8, and S9 may be some of the first electrodes TE1, TE2, TE3, and TE4 (or referred to as transfer electrodes) and the plurality of second electrodes RE1, RE2, RE3, RE4, RE5, and RE6 shown in FIG. 7.

The thickness TH1 in the vertical direction DRV (e.g., the third direction DR3) of the cover substrate 300a disposed on the sensor layer 200 illustrated in FIG. 8A is greater than the thickness TH2 in the vertical direction DRV (e.g., the third direction DR3) of the cover substrate 300b disposed on the sensor layer 200 illustrated in FIG. 8B.

Curves L11, L12, and L13 of the graph shown in FIG. 8A illustratively show signal levels (e.g., signal magnitudes) of the sensing signals SS. In the graph illustrated in FIG. 8A, the horizontal axis is a position of the sensor electrodes S1 to S9 in in one or more horizontal directions DRH (where the horizontal direction DRH as described herein will be understood to include one or more of the first and/or second directions DR1 and/or DR2), and the vertical axis is a signal level (signal magnitude) of the sensing signals SS received from the sensor electrodes S1 to S9. As described herein, said sensing signals SS may be received (e.g., generated at the sensor layer 200) based on an input (e.g., a first input 2001) applied from the input device 2000 to one or more of the sensor electrodes S1 to S9 (e.g., an electric signal transmitted from the input device 2000, a magnetic field generated by the input device 2000, etc.).

The curve L11 represents a signal level of the sensing signals SS when the input device 2000 is positioned adjacent to (e.g., overlapping in the vertical direction DRV) the sensor electrode S2. The curve L12 represents a signal level of the sensing signals SS when the input device 2000 is positioned adjacent to (e.g., overlapping in the vertical direction DRV) the sensor electrode S5. The curve L13 represents a signal level of the sensing signals SS when the input device 2000 is positioned adjacent to (e.g., overlapping in the vertical direction DRV) the sensor electrode S8.

As illustrated in FIG. 8A, when the thickness TH1 of the cover substrate 300a is relatively thick, the distance between the input device 2000 and the sensor electrodes S1 to S9 may be maintained to some extent. Accordingly, a first input 2001 from the input device 2000 may be transferred to multiple sensor electrodes, for example the sensor electrodes S4, S5, S6 adjacent to the input device 2000.

As a result, as shown in the curve L12, the first input 2001 from the input device 2000 may be evenly transferred to the sensor electrodes S1 to S9 such that the signal level of sensing signals transmitted by the sensor electrodes S1 to S9 may define a distribution peaking at the sensor electrode that is adjacent to (e.g., at least partially vertically overlapping) the input device 2000 (e.g., sensor electrode S5 as indicated by curve L12). Accordingly, the coordinate accuracy of the coordinate signal I-SS generated by the sensor controller 200C1 (see FIG. 7) may be high.

Curves L21, L22, and L23 of the graph shown in FIG. 8B illustratively show signal levels of the sensing signals SS. In the graph illustrated in FIG. 8B, the horizontal axis is a position of the sensor electrodes S1 to S9 in the first direction DR1, and the vertical axis is a signal level of the sensing signals SS received from the sensor electrodes S1 to S9.

The curve L21 represents a signal level of the sensing signals SS when the input device 2000 is positioned adjacent to (e.g., overlapping in the vertical direction DRV) the sensor electrode S2. The curve L22 represents a signal level of the sensing signals SS when the input device 2000 is positioned adjacent to (e.g., overlapping in the vertical direction DRV) the sensor electrode S5. The curve L23 represents a signal level of the sensing signals SS when the input device 2000 is positioned adjacent to (e.g., overlapping in the vertical direction DRV) the sensor electrode S8.

As illustrated in FIG. 8B, when the thickness TH2 of the cover substrate 300b is relatively thin (e.g., smaller than thickness TH1 shown in FIG. 8A), the distance between the input device 2000 and the sensor electrodes S1 to S9 is close. Thus, a first input 2001 (e.g., electric signal and/or magnetic field) from the input device 2000 may be transferred to only the sensor electrode S5 closest to the input device 2000.

Moreover, the signal level between two adjacent sensor electrodes, for example, the sensor electrodes S4 and S5, may be lowered, so that the coordinate accuracy of the coordinate signal I-SS generated by the sensor controller 200C1 (see FIG. 7) may be lowered.

FIG. 9 illustratively shows a cover substrate 300 according to some example embodiments of the present inventive concepts.

Referring to FIG. 9, the cover substrate 300 includes a first layer 310, a second layer 320, a third layer 330, and a fourth layer 340. In some example embodiments, the first layer 310, the second layer 320, the third layer 330, and the fourth layer 340 may be a first adhesive layer 310, a glass layer 320, a second adhesive layer 330, and a protective layer 340, respectively. In the following description, the first layer 310 is referred to interchangeably as a first adhesive layer 310, the second layer 320 is referred to interchangeably as a glass layer 320, the third layer 330 is referred to interchangeably as a second adhesive layer 330, and the fourth layer 340 is referred to interchangeably as a protective layer 340.

The first adhesive layer 310 is disposed on the sensor layer 200. The glass layer 320 is disposed on the first adhesive layer 310 so that the first adhesive layer 310 is between the glass layer 320 and the sensor layer 200. The second adhesive layer 330 is disposed on the glass layer 320 so that the glass layer 320 is between the second adhesive layer 330 and the first adhesive layer 310. The protective layer 340 is disposed on the second adhesive layer 330 so that the second adhesive layer 330 is between the protective layer 340 and the glass layer 320.

In some example embodiments, the first adhesive layer 310 may be disposed between the sensor layer 200 and the glass layer 320 and thus may be configured to bond the sensor layer 200 and the glass layer 320 together. The second adhesive layer 330 may be disposed between the glass layer 320 and the protective layer 340 and thus may be configured to bond the glass layer 320 and the protective layer 340 together. That is, the first adhesive layer 310, the glass layer 320, the second adhesive layer 330, and the protective layer 340 may be sequentially disposed on the sensor layer 200.

The dielectric constant of each of the first adhesive layer 310 and the second adhesive layer 330 (e.g., a dielectric constant in a particular direction such as a horizontal direction DRH) may have a first value. Restated, the first adhesive layer 310 may have a respective dielectric constant having the first value, and the second adhesive layer 330 may have a respective dielectric constant that also has the same first value. In some example embodiments, the dielectric constant of each of the first adhesive layer 310 and the second adhesive layer 330 may be 3 or less (e.g., between 0 and 3, between 0.01 and 3, between 0.1 and 3, between 1 and 3, etc.).

In some example embodiments, each of the first adhesive layer 310 and the second adhesive layer 330 may include an optically clear adhesive (OCA) film. However, the first adhesive layer 310 and the second adhesive layer 330 are not limited thereto, and may include a conventional adhesive or a pressure-sensitive adhesive. For example, the first adhesive layer 310 and the second adhesive layer 330 may each independently include an optically clear resin (OCR) or a pressure sensitive adhesive (PSA) film.

The glass layer 320 may be a chemically strengthened glass with increased strength through chemical surface treatment. The dielectric constant of the glass layer 320 may be a second value. Restated, the glass layer 320 may have a respective dielectric constant having a second value. In some example embodiments, the second value, which is the dielectric constant of the glass layer 320, may be greater than the first value, which is the dielectric constant of each of the first adhesive layer 310 and the second adhesive layer 330. In some example embodiments, the dielectric constant of the glass layer 320 may be 7.

In some example embodiments, the protective layer 340 may be formed by coating a material having a high dielectric constant (e.g., a high dielectric constant in the horizontal direction DRH). In some example embodiments, the protective layer 340 may include a metal oxide. The dielectric constant of the protective layer 340 may be a third value. Restated, the protective layer 340 may have a respective dielectric constant having a third value. The third value, which is the dielectric constant of the protective layer 340, may be greater than the first value, which is the dielectric constant of each of the first adhesive layer 310 and the second adhesive layer 330. The third value may be greater than, equal to, or smaller than the second value. For example, the third value may be 6, 7, or 8.

FIGS. 10A, 10B, and 10C illustratively show that a first input from the input device 2000 is transferred to the sensor layer 200 through the cover substrate 300.

Referring to FIG. 10A, when the input device 2000 is located on the sensor electrode S2 of the sensor layer 200 (e.g., on the cover substrate 300 and at least partially overlapping the sensor electrode S2 in the vertical direction DRV), a first input 2001 from the input device 2000 (e.g., an electric signal, magnetic field, etc.) may be transmitted to the sensor electrode S2 of the sensor layer 200 through the cover substrate 300.

Referring to FIG. 10B, when the input device 2000 is located between the sensor electrode S2 and the sensor electrode S3 of the sensor layer 200 (e.g., on the cover substrate 300 and offset from each of the sensor electrode S2 and the sensor electrode S3 so as to be between the sensor electrode S2 and the sensor electrode S3 in the horizontal direction DRH), a first input 2001 (e.g., electrical signal) from the input device 2000 may be transmitted to both the sensor electrode S2 and the sensor electrode 3 of the sensor layer 200 through the cover substrate 300.

Referring to FIG. 10C, when the input device 2000 is located on the sensor electrode S2 of the sensor layer 200 (e.g., on the cover substrate 300 and at least partially overlapping the sensor electrode S2 in the vertical direction DRV), a first input 2001 from the input device 2000 may be transmitted to the sensor electrode S1 and the sensor electrode S3 adjacent to the sensor electrode S2 as well as the sensor electrode S2 in the sensor layer 200 through the cover substrate 300.

The glass layer 320 and the protective layer 340 may each include a material having anisotropy with respect to an electric field. For example, the glass layer 320 and the protective layer 340 may have a dielectric anisotropic structure configured to exhibit a first dielectric constant in a first direction (e.g., a horizontal direction DRH) and a second dielectric constant in a second direction (e.g., a vertical direction DRV), for example based on said layer(s) generating (forming) an electric field in response to the first input 2001 being received at said layer(s), where the first dielectric constant is greater than the second dielectric constant. As a result, the glass layer 320 and the protective layer 340 may each be configured to form an electric layer that has a greater magnitude in the horizontal direction DRH than in the vertical direction DRV, such that the electric field(s) formed at the glass layer 320 and the protective layer 340 may be referred to as being formed in the horizontal direction DRH. That is, when the first input 2001 from the input device 2000 is transmitted to the glass layer 320 and the protective layer 340, the magnitude of the electric field formed in the horizontal direction DRH (e.g., first direction DR1 and/or second direction DR2) in each of the glass layer 320 or the protective layer 340 is greater than the magnitude of the electrical field formed in the vertical direction (e.g., third direction DR3).

The electric field may be formed in a vertical direction DRV (third direction DR3) in response to a first input 2001 from the input device 2000 being transferred to the first adhesive layer 310 and the second adhesive layer 330. Restated, the cover substrate 300 may be configured to form (generate) an electric field directed in the vertical direction DRV in response to the first input 2001 from the input device 2000 being transferred to the first adhesive layer 310 and the second adhesive layer 330. For example, the first adhesive layer 310 and the second adhesive layer 330 may each have a dielectric anisotropic structure configured to exhibit a first dielectric constant in a first direction (e.g., a vertical direction DRV) and a second dielectric constant in a second direction (e.g., a horizontal direction DRH), for example based on said layer(s) generating (forming) an electric field in response to the first input 2001 being received at said layer(s), where the first dielectric constant is greater than the second dielectric constant. As a result, the first adhesive layer 310 and the second adhesive layer 330 may each be configured to form an electric layer that has a greater magnitude in the vertical direction DRV than in the horizontal direction DRH, such that the electric field(s) formed at the first adhesive layer 310 and the second adhesive layer 330 may be referred to as being formed in the vertical direction DRV.

When the input device 2000 is located on the sensor electrode S2 of the sensor layer 200 (e.g., on the cover substrate 300 and at least partially overlapping the sensor electrode S2 in the vertical direction DRV), an electric field formed in the cover substrate 300 based on the first input applied thereto from the input device 2000 may be formed in a horizontal direction DRH in the protective layer 340, in a vertical direction DRV in the second adhesive layer 330, in a horizontal direction DRH in the glass layer 320, and in a vertical direction DRV in the first adhesive layer 310. As a result, the cover substrate 300 may be configured to cause the first input 2001 from the input device 2000 to be transmitted to the sensor electrode S2 through an electric field formed along the first path P1, and may be transmitted to a sensor electrode S3 through an electric field defined along the second path P2.

In order for the first input 2001 from the input device 2000 to be transmitted to the two or more sensor electrodes, each of the glass layer 320 and the protective layer 340 includes an anisotropic material (e.g., a material having a dielectric anisotropic structure), and the magnitude of the respective electric field formed at the glass layer 320 and the protective layer 340 in the horizontal direction DRH (e.g., the first direction DR1 and/or the second direction DR2) may be greater than the magnitude of the respective electric field formed in the vertical direction DRV (e.g., third direction DR3). That is, each of the glass layer 320 and the protective layer 340 may be configured to have anisotropy with respect to an electric field, and may be formed such that a dielectric constant of each of the glass layer 320 and the protective layer 340 (e.g., exhibited thereby) in a horizontal direction DRH (e.g., a first dielectric constant in a first direction) is greater than a dielectric constant of each of the glass layer 320 and the protective layer 340 (e.g., exhibited thereby) in the vertical direction DRV (e.g., a second dielectric constant in a second direction intersecting the first direction). As a result, the first input from the input device 2000 may be transferred to the plurality of sensor electrodes of the sensor layer 200, such that the sensing signals received from sensor electrodes adjacent the input device 2000 (and additional sensor electrodes adjacent to such sensor electrodes) may define a distribution such as shown in FIG. 8A, thereby enabling the coordinate accuracy of the coordinate signal I-SS generated by the sensor controller 200C1 (see FIG. 7) to be improved even with a reduced thickness TH2 of the cover substrate 300 in the vertical direction DRV such as shown in FIG. 8B, thereby improving the functionality of the display module DM and any electronic device 1000 including same. Thus, the thickness of the cover substrate 300 may be reduced, and integration of the display module DM and the electronic device 1000 may be improved without compromising input sensing performance by the display module DM, thereby improving the functionality of the display module DM and any electronic device 1000 including same.

In some example embodiments, at least one layer of the first adhesive layer 310, the glass layer 320, the second adhesive layer 330, or the protective layer 340 includes a material configured to form an electric field based on a first input 2001 (e.g., electric signal) received at the at least one layer from an input device 2000 such that a magnitude of the electric field in a first direction (e.g., in one of the horizontal direction DRH or the vertical direction DRV) is greater than a magnitude of the electric field in a second direction that intersects the first direction (e.g., in the other of the horizontal direction DRH or the vertical direction DRV), for example a material configured to exhibit dielectric anisotropy, such material referred to herein as defining a dielectric anisotropic structure. For example, as shown in FIG. 10C, the glass layer 320 and the protective layer 340 may each include a material configured to exhibit a greater dielectric constant in the horizontal direction DRH than in the vertical direction DRV (e.g., a dielectric anisotropic structure) and may be configured to form an electric field based on the first input 2001 received from the input device 2000 such that a magnitude, in the glass layer 320 and the protective layer 340, of the electric field in the horizontal direction DRH is greater than a magnitude, in the glass layer 320 and the protective layer 340, of the electric field in the vertical direction DRV. For example, as shown in FIG. 10C, the first and second adhesive layers 310 and 330 may each include a material having a smaller dielectric constant in the horizontal direction DRH than in the vertical direction DRV and may be configured to form an electric field based on the first input 2001 received from the input device 2000 such that a magnitude of the electric field in the vertical direction DRV is greater than a magnitude of the electric field in the horizontal direction DRH.

In some example embodiments, including the example embodiments shown in FIGS. 10A, 10B, and 10C, the cover substrate 300 is shown to include the first adhesive layer 310, the glass layer 320, the second adhesive layer 330, and the protective layer 340, but the present inventive concepts are not limited thereto.

In some example embodiments, the number (quantity) of layers included in the cover substrate 300 may vary. In some example embodiments, the number of layers included in the cover substrate 300 may be four or more. That is, the cover substrate 300 may further include, in addition to the first adhesive layer 310, the glass layer 320, the second adhesive layer 330, and the protective layer 340, one or more of an adhesive layer, a layer containing a metal oxide, an additional layer coated with a material having a high dielectric constant, and the like. The one or more additional layers may be disposed on at least one of the first adhesive layer 310, the glass layer 320, the second adhesive layer 330, or the protective layer 340 (e.g., one or more layers of the first adhesive layer 310, the glass layer 320, the second adhesive layer 330, or the protective layer 340).

In some example embodiments, the cover substrate 300 may sequentially include layers having a low dielectric constant, a high dielectric constant, a low dielectric constant and a high dielectric constant in the vertical direction DRV. It will be understood that, where dielectric constants of various layers are described and compared and/or contrasted between various layers herein (e.g., respective dielectric constants of the first adhesive layer 310, the glass layer 320, the second adhesive layer 330, the protective layer 340, or any combination thereof) said dielectric constants may each be dielectric constants in a same direction of a vertical direction DRV or a horizontal direction DRH, or may refer to a same ratio of dielectric constant in one direction (e.g., the horizontal direction DRH) to dielectric constant in another direction (e.g., the vertical direction DRV).

In some example embodiments, the cover substrate 300 may sequentially include layers having a high dielectric constant, a low dielectric constant, a low dielectric constant, a high dielectric constant, a low dielectric constant, and a low dielectric constant in the vertical direction DRV.

In some example embodiments, the cover substrate 300 may sequentially include layers having a low dielectric constant, a low dielectric constant, a high dielectric constant, a low dielectric constant, a low dielectric constant and a high permittivity sequentially in the vertical direction DRV.

In some example embodiments, the cover substrate 300 may sequentially include layers having a high dielectric constant, a low dielectric constant, a lower dielectric constant, and a lower dielectric constant in the vertical direction DRV.

In some example embodiments, the cover substrate 300 may sequentially include layers having a low dielectric constant, a low dielectric constant, a low dielectric constant, and a high dielectric constant in the vertical direction DRV.

In some example embodiments, a layer having a low dielectric constant may transmit a first input from the input device 2000 in the vertical direction vertical direction DRV, such as the first adhesive layer 310 and the second adhesive layer 330.

In some example embodiments, a layer having a high dielectric constant may transmit a first input from the input device 2000 in a horizontal direction DRH, such as the glass layer 320 and the protective layer 340. That is, the layer having a high dielectric constant may include an anisotropic material (e.g., having an anisotropic dielectric structure) in which a dielectric constant in a horizontal direction DRH is higher than a dielectric constant in the vertical direction DRV.

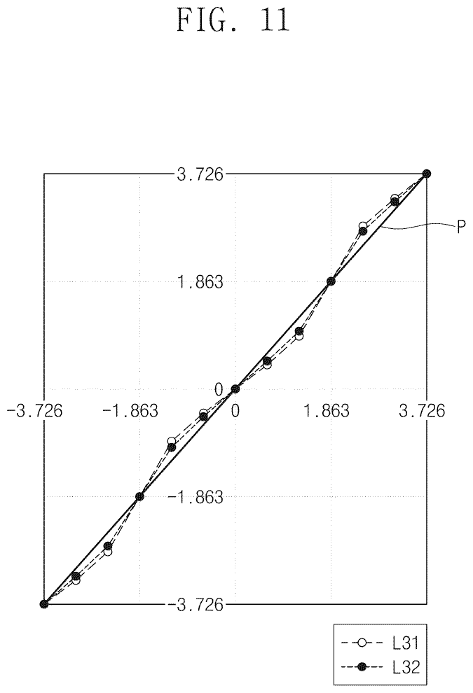

FIG. 11 is a diagram illustratively showing coordinate accuracy of an electronic device according to some example embodiments.

In the graph illustrated in FIG. 11, a horizontal axis represents the position of the sensor layer 200 illustrated in FIG. 7 in the first direction DR1, and a vertical axis represents the position in the second direction DR2 of the sensor layer 200.

Reference points (0, 0) in FIG. 11 represent an arbitrary position of the sensor layer 200 shown in FIG. 7.

Referring to FIG. 11, a line P indicates a position of the input device 2000 on the sensor layer 200 (e.g., on the cover substrate 300 and overlapping the sensor layer in the third direction DR3 shown in FIG. 7). The line L31 represents coordinates (e.g., in the first and second directions DR1 and DR2) of the input device 2000 sensed by the electronic device according to the prior art when the input device 2000 is at a position on the sensor layer 200 corresponding to the line P. The line L32 represents coordinates of the input device 2000 sensed by the electronic device 1000 according to the present inventive concepts (e.g., including a cover substrate 300 such as shown in FIGS. 9 and 10A-10C) when the input device 2000 is at a position on the sensor layer 200 corresponding to the line P.

The coordinates of the input device 2000 (e.g., in the first and second directions DR1 and DR2) sensed by the electronic device when the input device 2000 is at a position on the line P may be different (ex. an error) from the actual position of the input device 2000.

The maximum error between the actual position of the input device 2000 and the coordinate position sensed by the electronic device according to the prior art is 0.339 mm. The maximum error between the actual position of the input device 2000 and the coordinate position sensed by the electronic device 1000 according to the present inventive concepts is 0.223 mm. That is, it may be seen that the coordinate error of the electronic device 1000 according to the present inventive concepts is improved by 31% compared to the prior art.

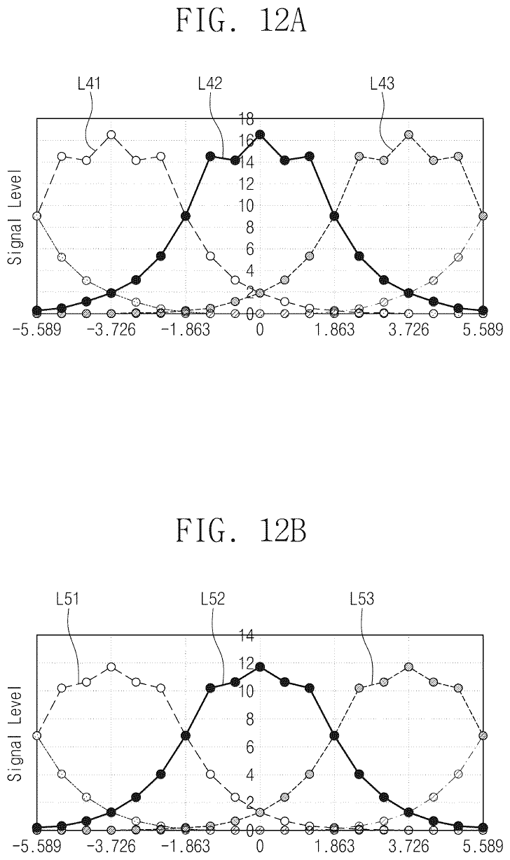

FIGS. 12A and 12B illustratively show signal levels of the sensing signals when a first input from the input device is transferred to the sensor layer 200.

FIG. 12A illustratively illustrates a signal level of the sensing signals of a conventional electronic device. FIG. 12B illustratively shows a signal level of the sensing signals SS of the electronic device according to the present inventive concepts (e.g., a sensor layer 200 of a display module DM including a cover substrate 300 such as shown in FIGS. 9 and 10A-10C, said sensor layer 200 including at least sensor electrodes S1 to S3 as shown in FIGS. 9 and 10A-10C).

In the graphs illustrated in FIGS. 12A and 12B, each horizontal axis is the position of the sensor layer 200 (see FIG. 7) in the first direction DR1 (e.g., units in millimeters with the horizontal axis being at a center of a given sensor electrode S2 of the sensor layer 200 such as shown in FIG. 10C), and each vertical axis is the signal level of the sensing signals SS received from the sensor layer 200. Curves L41, L42, and L43 of the graph shown in FIG. 12A and curves L51, L52, and L53 of the graph shown in FIG. 12B illustratively show signal levels (e.g., signal magnitudes) of the sensing signals SS. In the graphs illustrated in FIGS. 12A and 12B, the horizontal axis is a position of the sensor electrodes S1 to S3 in in one or more horizontal directions DRH (which may include one or more of the first and second directions DR1 and DR2) with the horizontal axis origin being at a center of sensor electrode S2, and positions (0,−3.726) and (0,+3.726) being a center of the sensor electrodes S1 and S3, respectively. As described herein, said sensing signals SS may be received (e.g., generated at the sensor layer 200) based on an input (e.g., a first input 2001) applied from the input device 2000 to one or more of the sensor electrodes S1 to S3 (e.g., an electric signal transmitted from the input device 2000, a magnetic field generated by the input device 2000, etc.).

The curves L41 and L51 each represent a signal level of the sensing signals SS when the input device 2000 is positioned adjacent to (e.g., overlapping in the vertical direction DRV) the sensor electrode S1. The curves L42 and L52 each represent a signal level of the sensing signals SS when the input device 2000 is positioned adjacent to (e.g., overlapping in the vertical direction DRV) the sensor electrode S2. The curves L43 and L53 each represent a signal level of the sensing signals SS when the input device 2000 is positioned adjacent to (e.g., overlapping in the vertical direction DRV) the sensor electrode S3.

Comparing FIGS. 10C, 12A, and 12B, the electronic device 10 (see FIG. 1) according to the present inventive concepts may evenly transmit the first input 2001 from the input device 2000 to the sensor electrodes S1, S2, and S3 of the sensor layer 200, as shown in FIG. 12B for example. As a result, the sensing signals SS have a gentle shape (e.g., exhibit a more continuous distribution of sensing signal levels generated at the sensor layer 200 according to respective sensor electrodes) along the first direction DR1 of the sensor layer 200, which may enable the electronic device 1000 to more accurately process the sensing signals SS to determine coordinates of the input device 2000 on the sensor layer 200 (e.g., a more continuous distribution of sensing signal levels may be more easily processed by the electronic device 1000 to identify coordinates indicated by the distribution of such signal levels. That is, even when the input device 2000 is positioned between the sensor electrodes S1, S2, and S3 in the first and/or second directions DR1 and/or DR2 (i.e., in a horizontal direction DRH), the electronic device 1000 may accurately detect the coordinates of the input device 2000. Accordingly, the input sensing performance of the display module DM and any electronic device including same may be improved.

Moreover, a first input from the input device 2000 may be transferred to the plurality of sensor electrodes of the sensor layer 200 even if the thickness of the cover substrate 300 in the vertical direction DRV (e.g., third direction DR3, such as shown in FIGS. 7 and 9) is as thin as the thickness TH2 of the cover substrate 300b shown in FIG. 8B. Accordingly, the thickness of the cover substrate 300 and thus of the display module DM may be reduced without compromising input coordinate sensing performance of the sensor layer 200 (and thus of the display module DM and any electronic device including same).

Also, even if the thickness of the cover substrate 300 in the third direction DR3 is as thick as the thickness TH1 of the cover substrate 300a shown in FIG. 8A, the first input from the input device 2000 may be better transferred to the plurality of sensor electrodes of the sensor layer 200.

According to the description above, the cover substrate of the electronic device having such a configuration can improve pen input sensitivity by including at least one layer (e.g., a protective layer) having a dielectric anisotropic structure in which the dielectric constant in the horizontal direction DRH is higher (greater) than the dielectric constant in the vertical direction DRV. As described herein, the horizontal direction DRH may be an in-plane direction of a plane in which one or more layers of the display module DM extend, while the vertical direction DRV may be perpendicular to such in-plane direction.

As described herein, any devices, systems, modules, portions, units, controllers, circuits, and/or portions thereof according to any of the example embodiments, and/or any portions thereof (including, without limitation, electronic device 1000, processor PP, memory MM, display module DM, power module PM, smartphone 10_1a, tablet PC 10_1b, laptop 10_1c, TV 10_1d, desk monitor 10_1e, smart glasses 10_2a, head mounted display 10_2b, smart watch 10_2c, an electronic device for a vehicle 10_3, display driver 100C, driving controller 100C1, data driving circuit 100C2, scan driving circuit 100C3, sensor driver 200C, sensor controller 200C1, signal generation circuitry 200C2, input detection circuit 200C3, input device 2000, any portion thereof, or the like) may include, may be included in, and/or may be implemented by one or more instances of processing circuitry such as hardware including logic circuits; a hardware/software combination such as a processor executing software; or a combination thereof. For example, the processing circuitry more specifically may include, but is not limited to, a central processing unit (CPU), an arithmetic logic unit (ALU), a graphics processing unit (GPU), an application processor (AP), a digital signal processor (DSP), a microcomputer, a field programmable gate array (FPGA), and programmable logic unit, a microprocessor, application-specific integrated circuit (ASIC), a neural network processing unit (NPU), an Electronic Control Unit (ECU), an Image Signal Processor (ISP), and the like. In some example embodiments, the processing circuitry may include a non-transitory computer readable storage device (e.g., a memory), for example a solid state drive (SSD), storing a program of instructions, and a processor (e.g., CPU) configured to execute the program of instructions to implement the functionality and/or methods performed by some or all of any devices, systems, modules, portions, units, controllers, circuits, and/or portions thereof according to any of the example embodiments.

While the present inventive concepts have been described above with reference to some example embodiments thereof, it will be understood by those skilled in the art or those skilled in the relevant art that various modifications and changes may be made to the present inventive concepts without departing from the spirit and technical scope of the present inventive concepts as set forth in the following claims. Therefore, the technical scope of the present inventive concepts should not be limited to the contents described in the detailed description of the specification, but should be determined by the claims.

What is claimed is:

1. An electronic device, comprising:
a display layer configured to display an image;
a sensor layer on the display layer; and
a cover substrate on the sensor layer,
wherein the cover substrate includes
a first layer on the sensor layer,
a second layer on the first layer,
a third layer on the second layer, and
a fourth layer on the third layer, and
wherein at least one layer of the first layer, the second layer, the third layer, or the fourth layer includes a material configured to form an electric field based on a first input received at the at least one layer from an input device such that a magnitude of the electric field in a first direction is greater than a magnitude of the electric field in a second direction that intersects the first direction.

2. The electronic device of claim 1, wherein the at least one layer has a dielectric anisotropic structure configured to exhibit a first dielectric constant in the first direction and a second dielectric constant in the second direction, the first dielectric constant greater than the second dielectric constant.

3. The electronic device of claim 1, wherein each layer of the second layer and the fourth layer has a dielectric anisotropic structure configured to exhibit a first dielectric constant in the first direction and a second dielectric constant in the second direction, the first dielectric constant greater than the second dielectric constant.

4. The electronic device of claim 3, wherein
the first layer includes a first adhesive layer, the first adhesive layer coupling the sensor layer and the second layer together, and
the third layer includes a second adhesive layer, the second adhesive layer coupling the second layer and the fourth layer together.

5. The electronic device of claim 4, wherein
a dielectric constant of the second layer is greater than a dielectric constant of the first layer, and
a dielectric constant of the fourth layer is greater than the dielectric constant of the first layer.

6. The electronic device of claim 4, wherein the second layer comprises a chemically strengthened glass.

7. The electronic device of claim 4, wherein the fourth layer comprises a metal oxide.

8. The electronic device of claim 1, wherein the cover substrate further includes at least one additional layer, the at least one additional layer on one or more layers of the first layer, the second layer, the third layer, or the fourth layer.

9. The electronic device of claim 1, wherein
the display layer includes:
a base layer;
a circuit layer on the base layer;
a light emitting element layer on the circuit layer; and
an encapsulation layer on the light emitting element layer, and
the sensor layer is directly on the encapsulation layer.

10. The electronic device of claim 1, wherein the sensor layer comprises
a plurality of first electrodes, and
a plurality of second electrodes, the plurality of second electrodes intersecting the plurality of first electrodes.

11. An electronic device, comprising:
a processor configured to transmit a control signal and an input image signal; and
a display module configured to display an image in response to the control signal and the input image signal,
wherein the display module includes
a display layer configured to display the image,
a sensor layer on the display layer, and
a cover substrate on the sensor layer,
wherein the cover substrate includes
a first layer on the sensor layer,
a second layer on the first layer,
a third layer on the second layer, and
a fourth layer on the third layer, and
wherein at least one layer of the first layer, the second layer, the third layer, or the fourth layer includes a material configured to form an electric field based on a first input received at the at least one layer from an input device such that a magnitude of the electric field in a first direction is greater than a magnitude of the electric field in a second direction that intersects the first direction.

12. The electronic device of claim 11, wherein the at least one layer has a dielectric anisotropic structure configured to exhibit a first dielectric constant in the first direction and a second dielectric constant in the second direction, the first dielectric constant greater than the second dielectric constant.

13. The electronic device of claim 11, wherein each layer of the second layer and the fourth layer has a dielectric anisotropic structure configured to exhibit a first dielectric constant in the first direction and a second dielectric constant in the second direction, the first dielectric constant greater than the second dielectric constant.

14. The electronic device of claim 13, wherein
the first layer includes a first adhesive layer, the first adhesive layer coupling the sensor layer and the second layer together, and
the third layer includes a second adhesive layer, the second adhesive layer coupling the second layer and the fourth layer together.

15. The electronic device of claim 14, wherein
a dielectric constant of the second layer is greater than a dielectric constant of the first layer, and
a dielectric constant of the fourth layer is greater than the dielectric constant of the first layer.

16. The electronic device of claim 14, wherein
the second layer comprises a chemically strengthened glass, and
the fourth layer comprises a metal oxide.

17. The electronic device of claim 11, wherein the cover substrate further includes at least one additional layer, the at least one additional layer on one or more layers of the first layer, the second layer, the third layer, or the fourth layer.

18. The electronic device of claim 11, wherein
the display layer includes:
a base layer;
a circuit layer on the base layer;
a light emitting element layer on the circuit layer; and
an encapsulation layer on the light emitting element layer, and
the sensor layer is directly on the encapsulation layer.

19. The electronic device of claim 11, wherein the sensor layer comprises a plurality of first electrodes and a plurality of second electrodes, the plurality of second electrodes intersecting the plurality of first electrodes.

20. The electronic device of claim 11, wherein the display module is configured to transmit a coordinate signal to the processor, the coordinate signal corresponding to sensing signals generated at the sensor layer.
